(19) United States
(12) Patent Application Publication
(10) Pub. No.: US 2026/0213844 A1
(43) Pub. Date: Jul. 23, 2026

(54) ELECTRICAL/OPTICAL COMMUNICATION CONVERSION AGGREGATOR SYSTEM

(71) Applicant: Dell Products L.P., Round Rock, TX (US)

(72) Inventors: David Piehler, Mountain View, CA (US); Amnon Izhar, Newton, MA (US); Claudio DeSanti, Santa Cruz, CA (US)

(21) Appl. No.: 19/027,109

(22) Filed: Jan. 17, 2025

(51) Int. Cl. H04B 10/40; G02B 6/12; G02B 6/35; H04B 10/2575

(52) U.S. Cl. CPC H04B 10/40; G02B 6/35; H04B 10/25759; G02B 2006/12145

(57) ABSTRACT

A networked system includes networking devices, networked devices, and an electrical/optical communication conversion aggregator system. A chassis of the electrical/optical communication conversion aggregator system houses optical transmitter subsystems that are each coupled to a respective one of the networked devices via a respective electrical connection and to each of the networking devices via a respective optical connection, and optical receiver subsystems that are each coupled to each of the networking devices via a respective optical connection and to a respective one of the networked devices via a respective electrical connection. Each optical transmitter subsystem converts electrical communications received from its connected networked device to optical communications that it transmits to any of its connected networking devices, and each optical receiver subsystem converts optical communications received from any of its connected networking devices to electrical communications that it transmits to its connected networked device.

### BACKGROUND

The present disclosure relates generally to information handling systems, and more particularly to aggregating the conversion between electrical communications and optical communications transmitted and received by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, are often coupled together via switch devices in order to allow those computing devices to communicate with each other. Furthermore, in many situations, the distance between computing devices and switch devices is great enough that the electrical communications generated by the computing devices cannot be transmitted to the switch devices using active or passive electrical cabling (e.g., “copper” cabling) due to the signal degradation that would occur to those electrical communications over that distance, and require the use of electrical/optical transceiver devices to convert those electrical communications to optical communications that may be transmitted over much longer distances than electrical communications.

To provide a simplified example of the use of electrical/optical transceiver devices that involves a single communications link between a single computing device and a single switch device, respective electrical/optical transceiver devices are provided on each of the computing device and the switch device and connected together via an optical cable, with the electrical/optical transceiver device on the computing device converting the electrical communications generated by a component (e.g., a Network Interface Controller (NIC) device, a Graphics Processing Unit (GPU) device, a memory device, etc.) in the computing device to optical communications and transmitting those optical communications via the optical cable to the switch device, as well as converting optical communications received from the switch device (via the electrical/optical transceiver device on the switch device) to electrical communications and transmitting those electrical communications to the component in the computing device. Similarly, the electrical/optical transceiver device provided on the switch device will convert the electrical communications generated by a component in the switch device to optical communications and transmit those optical communications via the optical cable to the computing device, and will covert optical communications received from the computing device (via the electrical/optical transceiver device on the computing device) to electrical communications and transmit those electrical communications to the component in the switch device.

However, the number of communications links utilized by computing devices continues to grow, increasing the number of electrical/optical transceiver devices that are required to enable communications via those communication links. For example, consider a conventional Artificial Intelligence (AI) system that includes eight racks each housing eight server devices, with each server device including eight Graphics Processing Unit (GPU) devices that are each connected to a respective Network Interface Controller (NIC) device in that server device, resulting in each rack including (8 NIC devices/server device*8 server devices=) 64 NIC devices that each require an electrical/optical transceiver device. Furthermore, in order to provide a “rail-based scale-out” architecture for such an AI system, eight switch devices are provided, with each of the eight NICs in each server device connected to a respective one of those switch devices via a respective optical cable and corresponding electrical/optical transceiver device as described above. As will be appreciated by one of skill in the art in possession of the present disclosure, the use of such relatively large numbers of electrical/optical transceiver devices in the AI systems discussed above (as well as similar communications systems) complicates connectivity management by increasing the difficulty in providing the fabric configuration while reducing the reliability of that fabric configuration, and is responsible for a relatively large fraction of the overall costs, the power usage, the heat dissipation, and the latency associated with such systems.

Accordingly, it would be desirable to provide an electrical/optical communication conversion system that addresses the issues discussed above.

### SUMMARY

According to one embodiment, an electrical/optical communication conversion aggregator system includes a chassis; an aggregated networked device connector subsystem that is configured to couple to a plurality of networked devices via respective electrical connections; a plurality of networking device connectors that are configured to couple to a plurality of networking device via respective optical connections; a plurality of optical transmitter subsystems that are housed in the chassis, that are each configured to couple to a respective one of the plurality of networked devices via the aggregated networked device connector subsystem and to each of the plurality of networking devices via the plurality of networking device connectors, and that are each configured to convert electrical communications received from that networked device via the aggregated networked device connector subsystem to optical communications and transmit those optical communications to any of the plurality of networking devices via the plurality of networking device connectors; and a plurality of optical receiver subsystems that are housed in the chassis, that are each configured to couple to each of the plurality of networking devices via the plurality of networking device connectors and to a respective one of the plurality of networked devices via the aggregated networked device connector subsystem, and that are each configured to convert optical communications received from any of the plurality of networking devices via the plurality of networking device connectors to electrical communications and transmit those electrical communications to that networked device via the aggregated networked device connector subsystem.

### BRIEF DESCRIPTION OF THE DRAWINGS

FIG. 1 is a schematic view illustrating an embodiment of an Information Handling System (IHS).

FIG. 2 is a schematic view illustrating an embodiment of a networked system that may utilize the electrical/optical communication conversion aggregation system of the present disclosure.

FIG. 3 is a schematic view illustrating an embodiment of a rack of computing devices that may be included in the networked system of FIG. 2.

FIG. 4 is a schematic view illustrating an embodiment of a computing device that may be included in the rack of computing devices of FIG. 3.

FIG. 5 is a schematic view illustrating an embodiment of a networked device that may be included in the computing device of FIG. 4.

FIG. 6A is a schematic view illustrating an embodiment of an electrical/optical communication conversion aggregator system that may be provided in the networked system of FIG. 2.

FIG. 6B is a schematic view illustrating an embodiment of some of the connections that may be provided in the electrical/optical communication conversion aggregator system of FIG. 6A.

FIG. 6C is a schematic view illustrating an embodiment of some of the connections that may be provided in the electrical/optical communication conversion aggregator system of FIG. 6A.

FIG. 7 is a flow chart illustrating an embodiment of a method for aggregating the conversion between electrical communications and optical communications.

FIG. 8A is a schematic view illustrating an embodiment of some of the desired connectivity in the networked system of FIG. 2 during the method of FIG. 7.

FIG. 8B is a schematic view illustrating an embodiment of how the desired connectivity in the networked system of FIG. 8A is provided in the rack of computing devices of FIG. 3 during the method of FIG. 7.

FIG. 8C is a schematic view illustrating an embodiment of how the desired connectivity in the networked system of FIG. 8A and the rack of computing devices of FIG. 8B is provided in the computing device of FIG. 4 during the method of FIG. 7.

FIG. 9A is a schematic view illustrating an embodiment of some of the desired connectivity in the networked system of FIG. 2 during the method of FIG. 7.

FIG. 9B is a schematic view illustrating an embodiment of how the desired connectivity in the networked system of FIG. 9A is provided in the rack of computing devices of FIG. 3 during the method of FIG. 7.

FIG. 9C is a schematic view illustrating an embodiment of how the desired connectivity in the networked system of FIG. 9A and the rack of computing devices of FIG. 9B is provided in the computing device of FIG. 4 during the method of FIG. 7.

FIG. 10A is a schematic view illustrating an embodiment of some of the desired connectivity in the networked system of FIG. 2 during the method of FIG. 7.

FIG. 10B is a schematic view illustrating an embodiment of how the desired connectivity in the networked system of FIG. 10A is provided in the rack of computing devices of FIG. 3 during the method of FIG. 7.

FIG. 10C is a schematic view illustrating an embodiment of how the desired connectivity in the networked system of FIG. 10A and the rack of computing devices of FIG. 10B is provided in the computing device of FIG. 4 during the method of FIG. 7.

FIG. 11 is a schematic view illustrating a plurality of the electrical/optical communication conversion aggregator systems of FIGS. 6A-6C provided in the networked system of FIG. 2 during the method of FIG. 7.

FIG. 12A is a schematic view illustrating connections provided for one of the electrical/optical communication conversion aggregator systems of FIG. 11 during the method of FIG. 7.

FIG. 12B is a schematic view illustrating an embodiment of the connections provided via one of the electrical/optical communication conversion aggregator systems of FIG. 12A in the networked system of FIG. 11 during the method of FIG. 7.

FIG. 12C is a schematic view illustrating an embodiment of the connections provided via one of the electrical/optical communication conversion aggregator systems of FIG. 12A in the networked system of FIG. 11 during the method of FIG. 7.

FIG. 12D is a schematic view illustrating an embodiment of the connections provided via one of the electrical/optical communication conversion aggregator systems of FIG. 12A in the networked system of FIG. 11 during the method of FIG. 7.

FIG. 13A is a schematic view illustrating connections provided for one of the electrical/optical communication conversion aggregator systems of FIG. 11 during the method of FIG. 7.

FIG. 13B is a schematic view illustrating an embodiment of the connections provided via one of the electrical/optical communication conversion aggregator systems of FIG. 13A to the rack of computing devices of FIG. 3 during the method of FIG. 7.

FIG. 13C is a schematic view illustrating an embodiment of the connections provided via one of the electrical/optical communication conversion aggregator systems of FIG. 13A to the rack of computing devices of FIG. 4 during the method of FIG. 7.

FIG. 13D is a schematic view illustrating an embodiment of the connections provided via one of the electrical/optical communication conversion aggregator systems of FIG. 13A to the networked device of FIG. 5 during the method of FIG. 7.

FIG. 14A is a schematic view illustrating an embodiment of the rack of computing device of FIG. 4 operating during the method of FIG. 7.

FIG. 14B is a schematic view illustrating an embodiment of the networked device of FIG. 5 operating during the method of FIG. 7.

FIG. 14C is a schematic view illustrating an embodiment of the rack of computing device of FIG. 4 operating during the method of FIG. 7.

FIG. 14D is a schematic view illustrating an embodiment of the rack of computing device of FIG. 4 operating with the electrical/optical communication conversion aggregator system of FIG. 6A during the method of FIG. 7.

FIG. 14E is a schematic view illustrating an embodiment of the electrical/optical communication conversion aggregator system of FIG. 6A operating during the method of FIG. 7.

FIG. 14F is a schematic view illustrating an embodiment of the electrical/optical communication conversion aggregator systems in the networked system of FIG. 11 operating during the method of FIG. 7.

FIG. 15A is a schematic view illustrating an embodiment of the electrical/optical communication conversion aggregator systems in the networked system of FIG. 11 operating during the method of FIG. 7.

FIG. 15B is a schematic view illustrating an embodiment of the electrical/optical communication conversion aggregator system of FIG. 6A operating during the method of FIG. 7.

FIG. 15C is a schematic view illustrating an embodiment of the rack of computing device of FIG. 4 operating with the electrical/optical communication conversion aggregator system of FIG. 6A during the method of FIG. 7.

FIG. 15D is a schematic view illustrating an embodiment of the rack of computing device of FIG. 4 operating during the method of FIG. 7.

FIG. 15E is a schematic view illustrating an embodiment of the networked device of FIG. 5 operating during the method of FIG. 7.

FIG. 15F is a schematic view illustrating an embodiment of the rack of computing device of FIG. 4 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

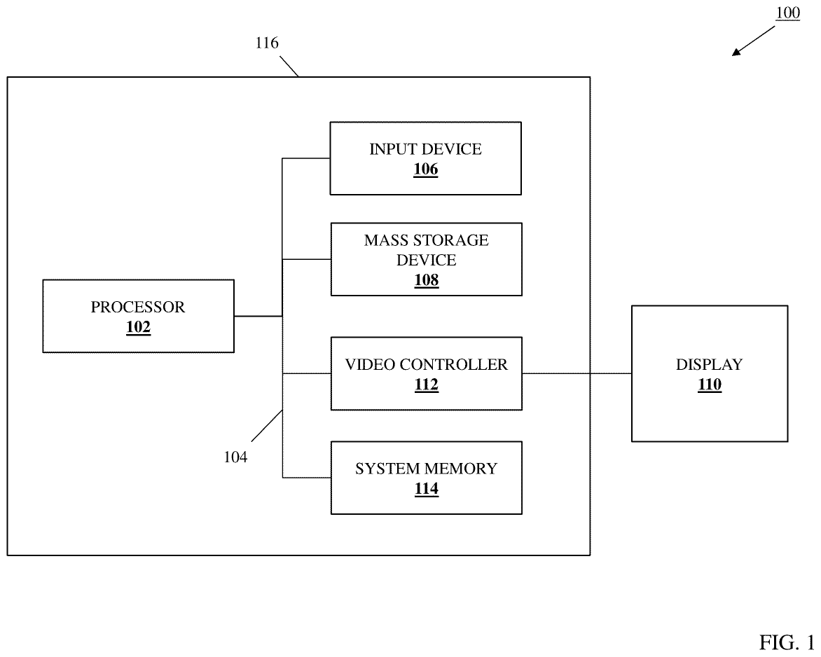

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

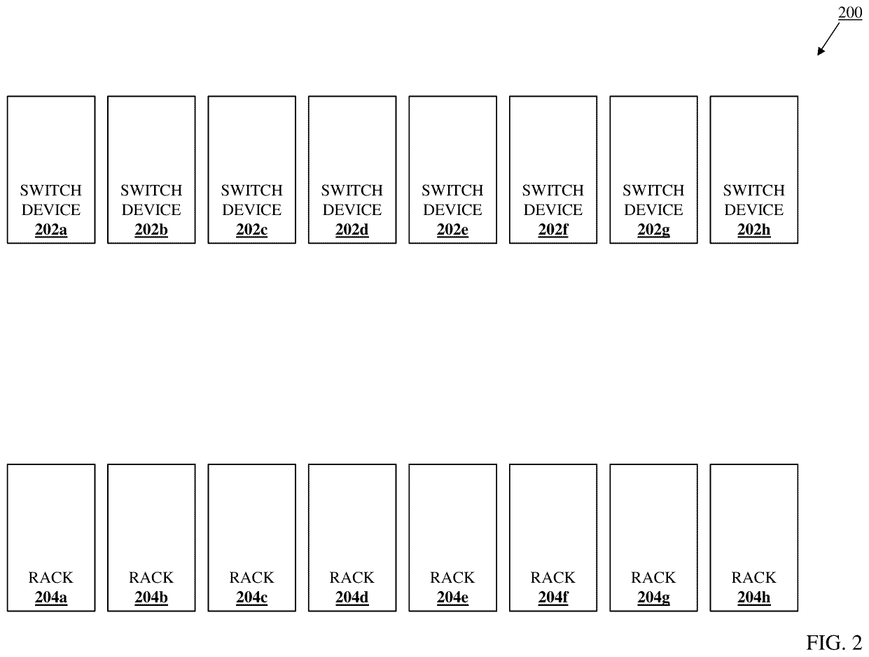

Referring now to FIG. 2, an embodiment of a networked system 200 is illustrated that may utilize the electrical/optical communication conversion aggregator system of the present disclosure. The networked system 200 includes a plurality of networking devices that, in the examples illustrated and described below, are provided by eight switch devices 202a, 202b, 202c, 202d, 202e, 202f, 202g, and 202h. In an embodiment, each of the switch devices 202a-202h may be provided by the IHS 100 discussed above with reference to FIG. 1, and/or may include some or all of the components of the IHS 100, and in specific examples may be provided by Z9864 Ethernet switch devices available from DELL® Inc. of Round Rock, Texas, United States. In the examples below, the Z 9864 Ethernet switch devices discussed above may include 64 800 Gigabit Ethernet (G) ports, 32 of which may be configured as “uplink” ports that are connected to a network, and 32 of which may each be connected to a respective 800G electrical/optical transceiver device having 2 400G ports in order to provide the 64 400G links between each switch device 202a-202h and the networked devices described below. However, while illustrated and discussed as being provided by a specific number of switch devices, one of skill in the art in possession of the present disclosure will recognize how different numbers and/or types of networking devices may be provided in the networked system 200 to utilize the electrical/optical communication conversion aggregator system of the present disclosure and may operate similarly as the switch devices 202a-202h discussed below.

The networked system 200 also includes eight racks 204a, 204b, 204c, 204d, 204e, 204f, 204g, and 204h, which as described below house the networked devices that utilize the electrical/optical communication conversion aggregator system of the present disclosure. However, while the networked devices that utilize the electrical/optical communication conversion aggregator system of the present disclosure are illustrated and described below as being housed in racks, one of skill in the art in possession of the present disclosure will appreciate how networked devices that utilize the electrical/optical communication conversion aggregator system of the present disclosure may be provided in a variety of manners that will fall within the scope of the present disclosure. As such, while a specific networked system 200 has been illustrated and described, one of skill in the art in possession of the present disclosure will recognize that the electrical/optical communication conversion aggregator system of the present disclosure may be utilized in networked systems have a variety of components and/or configurations while remaining within the scope of the present disclosure as well.

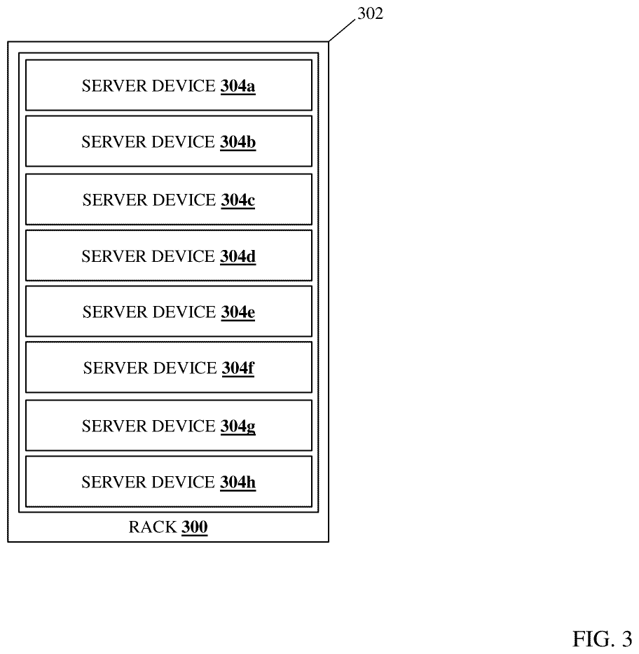

Referring now to FIG. 3, an embodiment of a rack 300 is illustrated that may provide any of the racks 204a-204h discussed above with reference to FIG. 2. The rack 300 includes chassis 302 that houses a plurality of computing devices that, in the examples illustrated and described below, are provided by eight server devices 304a, 304b, 304c, 304d, 304e, 304f, 304g, and 304h (also referred to as server “platforms”). In an embodiment, each of the server devices 304a-304h may be provided by the IHS 100 discussed above with reference to FIG. 1, and/or may include some or all of the components of the IHS 100, and in specific examples may be provided by XZE9680 server devices available from DELL® Inc. of Round Rock, Texas, United States. However, while illustrated and discussed as being provided by specific server devices, one of skill in the art in possession of the present disclosure will recognize how computing devices provided in the rack 300 may include any computing devices that may be configured to operate similarly as the server devices 304a-304h discussed below. Furthermore, while the rack 300 is illustrated as housing eight server devices 304a-304h that are described below as each including eight networked devices, one of skill in the art in possession of the present disclosure will appreciate how the rack 300 may house different numbers of networked devices while remaining within the scope of the present disclosure as well.

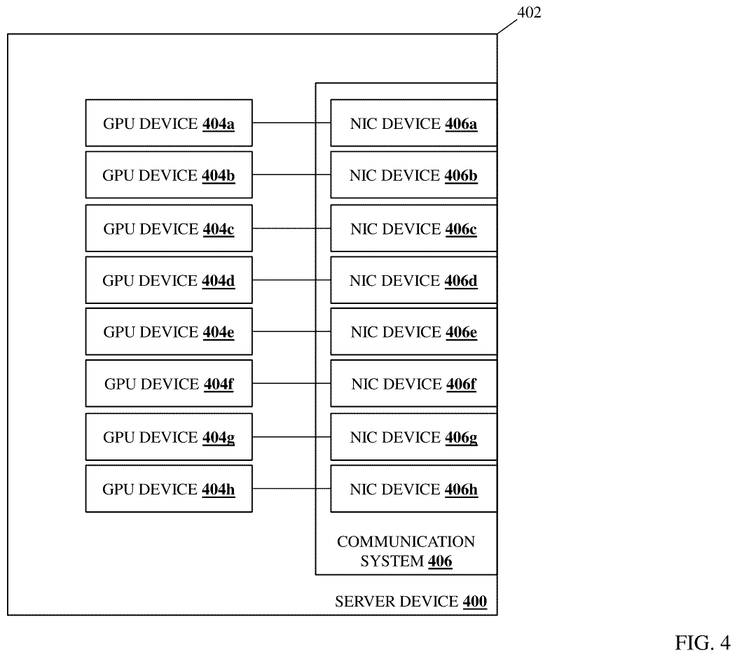

Referring now to FIG. 4, an embodiment of a server device 400 is illustrated that may provide any of the server devices 304a-304h discussed above with reference to FIG. 3. As such, the server device 400 may be provided by the IHS 100 discussed above with reference to FIG. 1 and/or may include some or all of the components of the IHS 100, and in specific examples may be provided by an XZE9680 server device available from DELL® Inc. of Round Rock, Texas, United States. However, while illustrated and discussed as being provided by a particular server device, one of skill in the art in possession of the present disclosure will recognize that the networked devices in the server device 400 discussed below may be included in other computing devices that are configured to operate similarly as the server device 400 discussed below.

In the illustrated embodiment, the server device 400 includes a chassis 402 that houses the components of the server device 400, only some of which are illustrated and described below. In the illustrated embodiment, the chassis 402 houses eight GPU devices 404a, 404b, 404c, 404d, 404e, 404f, 404g, and 404h. Furthermore, the chassis 402 also houses a communication system 406 that includes eight Network Interface Controller (NIC) devices 406a, 406b, 406c, 406d, 406e, 406f, 406g, and 406h, with each NIC device 406a-406h coupled to a respective one of the GPU devices 404a-404h in order to enable communications by that GPU device (i.e., the NIC device 406a is coupled to and enables communications for the GPU device 404a, the NIC device 406b is coupled to and enables communications for the GPU device 404b, and so on).

As will be appreciated by one of skill in the art in possession of the present disclosure, the NIC devices 406a-406h in the examples illustrated and described below provide the networked devices that utilize the electrical/optical communication conversion aggregator system of the present disclosure in order to enable the communications discussed above for their corresponding GPU devices 404a-404h, but while the server device 400 is illustrated and described as including eight NIC devices enabling communications for respective GPU devices, server devices and/or other computing devices that utilize the electrical/optical communication conversion aggregator system of the present disclosure may include any number and/or types of networked devices while remaining within the scope of the present disclosure as well.

As such, one of skill in the art in possession of the present disclosure will appreciate how networked devices used with the electrical/optical communication conversion aggregator system of the present disclosure may be provided by adapters, Ethernet adapters, Smart NICs, Data Processing Units (DPUs), Infrastructure Processing Units (IPUs), Host Bus Adapters (HBAs), Graphics Processing Units (GPUs), memory devices (e.g., Compute eXpress Logic (CXL) memory devices and/or other memory devices known in the art), and/or other networked devices that may include the relatively high-speed, DSP-based SERDES interface described as being included in the NIC devices 406a-406h in further detail below. In particular, the networked devices utilized according to the teachings of the present disclosure may be any networked devices that enable the linear transmission and reception of communications via the optical transmitter systems and optical receiver systems in the EOCCA systems described below.

As such, while a specific server device 400 has been illustrated and described, one of skill in the art in possession of the present disclosure will recognize that server devices (or other computing devices operating according to the teachings of the present disclosure in a manner similar to that described below for the server device 400) may include a variety of components and/or component configurations for providing conventional server functionality, as well as the electrical/optical-communication-conversion-aggregator-related functionality discussed below, while remaining within the scope of the present disclosure as well.

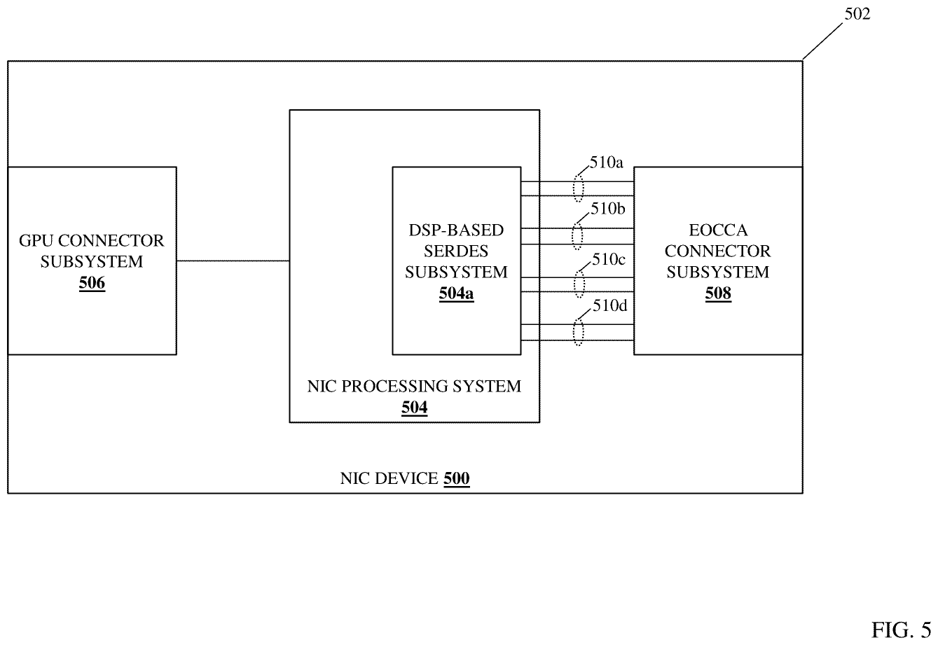

Referring now to FIG. 5, an embodiment of a NIC device 500 is illustrated that may provide any of the NIC devices 406a-406h discussed above with reference to FIG. 4. In the illustrated embodiment, the NIC device 500 includes a chassis 302 (e.g., a circuit board) that supports the components of the NIC device 500, only some of which are illustrated and described below. For example, the chassis 502 may support a NIC processing system 504 that is configured to perform any of a variety of NIC processing operations known in the art and that, in the examples illustrated and described below, includes a Digital Signal Processor (DSP)-based SERializer/DESerializer (SERDES) subsystem 504a is configured to perform any of a variety of SERDES operations known in the art such as, for example, signal retiming operations, reshaping and regeneration operations, pre-emphasis of out-going electrical signals operations, adaptive equalization of incoming signals operations, and/or other SERDES operations that would be apparent to one of skill in the art in possession of the present disclosure.

As will be appreciated by one of skill in the art in possession of the present disclosure, the DSP-based SERDES subsystem 504a may conform to either proprietary data transmission protocols or standard data transmission protocols and at various data rates and modulation formats. In addition, in order to enable the utilization of the “linear optics” discussed below, the DSP-based SERDES subsystem 504a may be configured to enable un-retimed, direct drive, linear optic communications to provide the Linear Pluggable Optic (LPO) functionality described below. As such, while the examples below utilize a 400 Gigabit Ethernet protocol based on four lanes of 106.25 GB/s PAM4 signals with each lane utilizing differential pair electrical signaling in the electrical domain and intensity modulation/direct detection in the optical domain, Ethernet protocols, Ultra-Ethernet (UEC) protocols, Infiniband protocols, Fibre Channel protocols, Peripheral Component Interconnect express (PCIe) protocols, Universal Chiplet Interconnect express (UCIe) protocols, Ultra Accelerator Link (UALink) protocols, NVLINK® protocols from NVIDIA® Corporation of Santa Clara, California, United States, and/or other protocols will fall within the scope of the present disclosure as well.

The chassis 502 also supports a GPU connector subsystem 506 that is configured to couple the NIC processing system 504 to a GPU device (e.g., any of the GPU devices 404a-404h discussed above with reference to FIG. 4). As illustrated, the chassis 502 also supports an Electrical/Optical Communication Conversion Aggregator (EOCCA) connector subsystem 508 that is configured to couple the DSP SERDES subsystem 504/NIC processing system 504 to the electrical/optical communication conversion aggregator system of the present disclosure. In the illustrated example, the EOCCA connector subsystem 508 is connected to the DSP-based SERDES subsystem 504a in the NIC processing system 504 via the differential pair connections 510a, 510b, 510c, and 510d illustrated in FIG. 5 (e.g., which may be provided by circuit board traces, passive “flyover” cables, combinations thereof, etc.), and one of skill in the art in possession of the present disclosure will appreciate how the EOCCA connector subsystem 508 provides a respective transmit/receive connection for transmit/receive signals that may be transmitted via each of the differential pair connections 510a-510d (i.e., four transmit/receive connections providing a total of four transmit signals and four receive signals).

However, while the NIC device 500 is illustrated and described below as including four differential pair connections 510a-510d, one of skill in the art in possession of the present disclosure will appreciate how the number of differential pair connections provided on networked devices like the NIC device 500 discussed below may be increased in both number of differential pair connections and corresponding SERDES lanes to the DSP-based SERDES subsystem 504a. For example, a particular embodiment may replace the NIC device 500 and its connected GPU device with a “BLACKWELL®” GPU system/compute tray available from NVIDIA® corporation of Santa Clara, California, United States. In such a GPU system/compute tray, four 36-lane 200 G PAM 4 DSP-based SERDES per GPU are coupled to the EOCCA connector subsystem 508 via 288 differential pair connections and corresponding 144 SERDES lanes per compute tray.

In a specific example, the EOCCA connector subsystem 508 may be provided by a Quad Small Form-factor Pluggable 112 (QSFP112) receptacle/connector that is configured to perform data transmission at 100 Gigabit Ethernet (100G) speeds using 4 level Pulse Amplitude Modulation (PAM4) (e.g., via a bundle of twinax passive copper cables), although other connectors (e.g., other Small Form-factor Pluggable (SFP) connectors, other QSFP connectors, QSFP Double Density (QSFP-DD) connectors, Octal Small Form-factor Pluggable (OSFP) connectors, OSFP eXtended Density (OSFP-XD) connectors, PALADIN® HD connectors available from AMPHENOL® corporation of Wallingford, Connecticut, United States, etc.) will fall within the scope of the present disclosure as well. To provide a specific example, the QSFP112 receptacle/connector that provides the EOCCA connector subsystem 508 discussed above maybe a female connector that is coupled to the DSP-based SERDES subsystem 504a via copper trace differential pair signaling lines, with male connectors for the EOCCA connector subsystem 508 (discussed below) provided by a QSFP112 pluggable module with eight differential pair cables.

However, while a specific NIC device 500 has been illustrated and described, one of skill in the art in possession of the present disclosure will recognize that NIC devices (or other networked devices operating according to the teachings of the present disclosure in a manner similar to that described below for the NIC device 500) may include a variety of components and/or component configurations for providing conventional NIC device functionality, as well as the electrical/optical-communication-conversion-aggregator-related functionality discussed below, while remaining within the scope of the present disclosure as well.

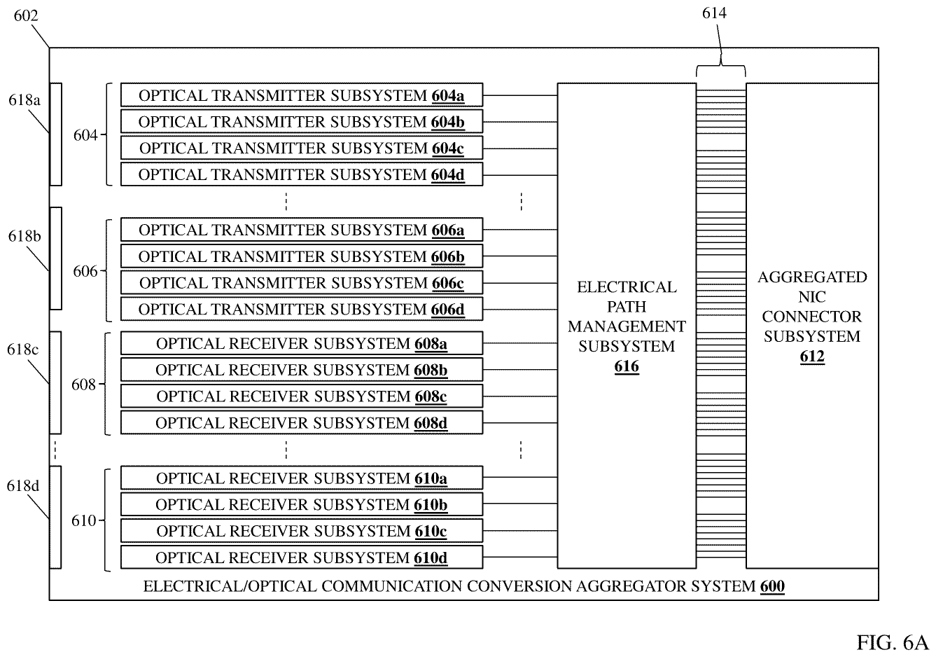

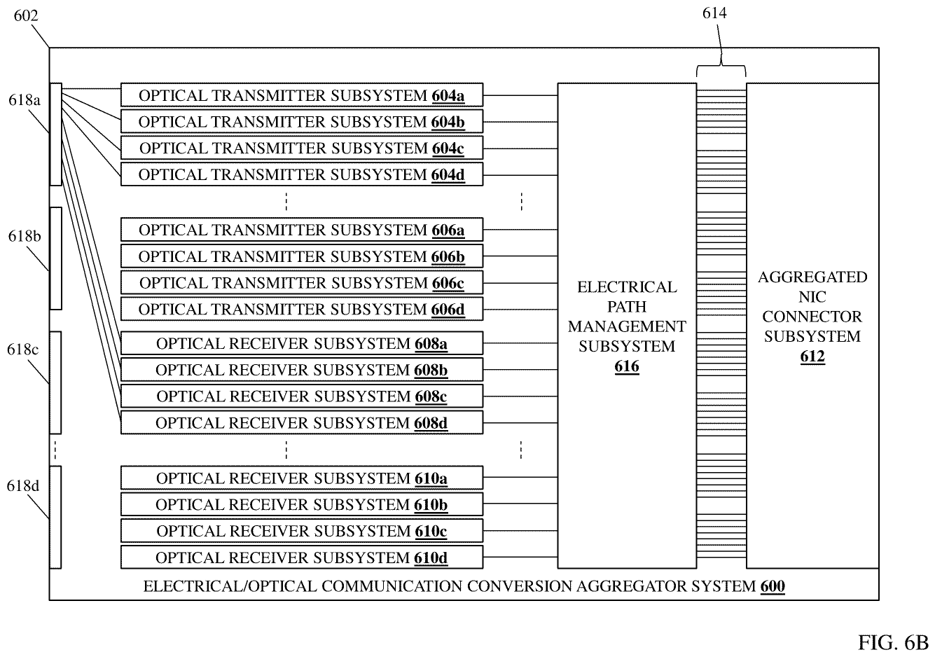

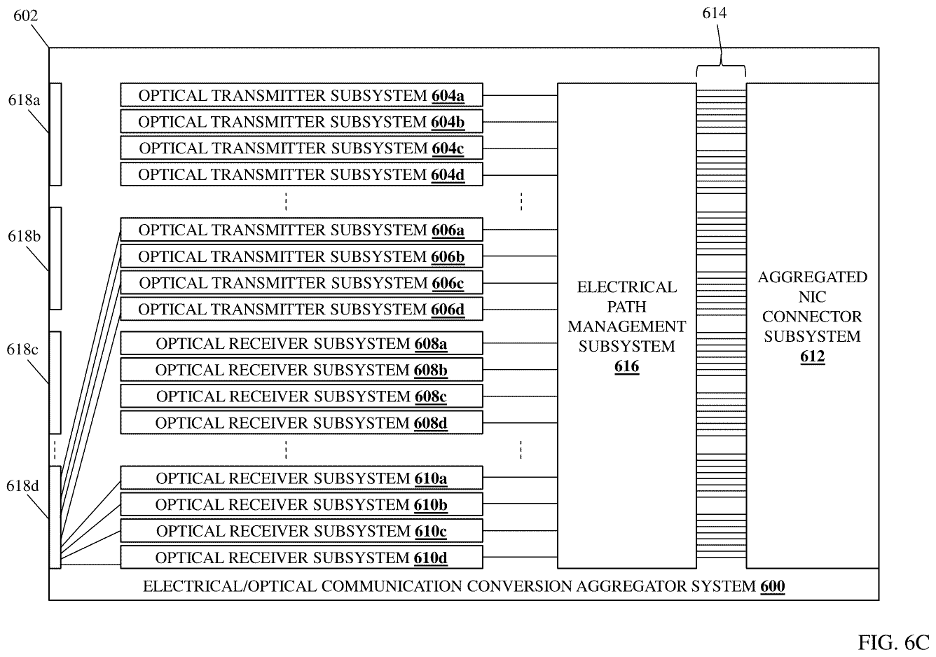

Referring now to FIG. 6A, an embodiment of an electrical/optical communication conversion aggregator system 600 is illustrated that may be provided according to the teachings of the present disclosure. In the illustrated embodiment, the electrical/optical communication conversion aggregator system 600 includes a chassis 602 that houses or supports the components of the electrical/optical communication conversion aggregator system 600, only some of which are illustrated and described below. As described below, in some examples the electrical/optical communication conversion aggregator system 600 may be configured to be housed in a rack, and thus the chassis 602 may be dimensioned and/or otherwise configured to be housed in that rack (e.g., the chassis 602 may be provided with a 1 Rack Unit (RU) height, as well as other dimensions that one of skill in the art in possession of the present disclosure will recognize allow it to be housed in a rack).

However, while described as being housed in a rack, one of skill in the art in possession of the present disclosure will appreciate how the electrical/optical communication conversion aggregator system 600 may be provided outside a rack while remaining within the scope of the present disclosure as well. For example, the electrical/optical communication conversion aggregator system 600 may be provided by one or more boards (e.g., circuit boards) that are configured to be connected to a “platform”, “shelf”, or “back panel” via the aggregated NIC connector subsystems discussed below. In another example, the electrical/optical communication conversion aggregator system 600 may be provided by a pluggable module that is configured to connect directly to one or more GPU devices (e.g., the electrical/optical communication conversion aggregator system 600 may be configured to connect directly to the 144 differential pair connections on the GPU systems described below that are available from NVIDIA® corporation of Santa Clara, California, United States).

As illustrated, the chassis 602 may house a plurality of optical transmitter systems 604 and up to 606, with each optical transmitter system 604-606 including a plurality of optical transmitter subsystems (i.e., with the optical transmitter system 604 including four optical transmitter subsystems 604a, 604b, 604c, and 604d in the illustrated examples; and with the optical transmitter system 606 including four optical transmitter subsystems 606a, 606b, 606c, and 606d in the illustrated examples). In a specific example, the optical transmitter subsystems in the optical transmitter systems 604-606 need not include a DSP SERDES subsystem or retimer subsystem like those included in conventional transceiver devices, as the DSP SERDES subsystems in the NIC devices 406a-406h/500 may be configured to transmit signals with sufficient power and quality to enable un-retimed, direct-drive, linear operation of the optical transmitter subsystem, and with the DSP-based SERDES subsystems included in the switch devices 202a-202h (e.g., embedded in or coupled to the switching ASIC) or coupled to the switch devices 202a-202h (e.g., via a DSP-based SERDES retimed pluggable optical module) described above also configured to receive signals with sufficient equalization capabilities to enable un-retimed, direct-drive, linear operation of the optical transmitter subsystem (e.g., with each optical transceiver subsystem including un-retimed linear driver functionality).

Furthermore, the chassis 302 may also house a plurality of optical receiver systems 608 and up to 610, with each optical receiver system 608-610 including a plurality of optical receiver subsystems (i.e., with the optical receiver system 608 including four optical receiver subsystems 608a, 608b, 608c, and 608d in the illustrated examples; and with the optical receiver system 610 including four optical receiver subsystems 610a, 610b, 610c, and 610d in the illustrated examples). In a specific example, the optical receiver subsystems in the optical receiver systems 608-610 need not include a DSP-based SERDES subsystem or retimer subsystem like those included in conventional transceiver devices, as the DSP-based SERDES subsystems within the switch devices 202a-202h described above may be configured to transmit signals with sufficient power and quality to enable un-retimed, direct-drive, linear operation, and with the DSP-based SERDES subsystems 504a in the NIC devices 406a-406h/500 described above configured to receive signals with sufficient equalization capabilities to enable un-retimed, linear operation of optical receiver systems 608a-608d and up to 610a-610d (e.g., with each optical receiver subsystem including un-retimed electrical amplification functionality). As will be appreciated by one of skill in the art in possession of the present disclosure, the un-retimed optical transmitter and optical receiver functionality described above may be enabled on a common device (e.g., via an Application-Specific Integrated Circuit (ASIC), with the physical arrangement of optical transmitter subsystems and optical receiver subsystems on the chassis 602 optimized).

In specific examples, the optical transmitter systems 604-606 may include an array of Vertical Cavity Surface Emitting Lasers (VCSELs), an array of optical modulators fabricated on a silicon photonic substrate (or other substrate), an array of Distributed FeedBack (DFB) lasers or DFB laser/electro-absorption modulators fabricated on an Indium Phosphide (InP) substrate, and/or any other optical transmitter components/technologies that would be apparent to one of skill in the art in possession of the present disclosure. In other specific examples, the optical receiver systems 608-610 may be a planar array of photoreceivers, may be part of an integrated optical/planar solution, and/or may be provided using any other optical receiver components/technologies that would be apparent to one of skill in the art in possession of the present disclosure. However, while array-type solutions have been described, one of skill in the art in possession of the present disclosure will appreciate how the optical transmitter systems 604-606 and the optical receiver systems 608-610 may be provided by individual, discrete, optical transmitters and receivers while remaining within the scope of the present disclosure as well.

As will be appreciated by one of skill in the art in possession of the present disclosure, each optical transmitter subsystem discussed above may include an optical fiber, an optical transmitter, and an analog linear electronic driver that is configured to receive electrical communications (e.g., electrical signals) and use those electrical communications to drive the optical transmitter to transmit optical communications (e.g., optical signals) via the optical fiber. Similarly, one of skill in the art in possession of the present disclosure will appreciate how each optical receiver subsystem discussed above may include an optical fiber, an optical receiver, and a Transimpedance Amplifier (TIA) along with an analog post amplifier and an electrical post amplifier that are configured to receive optical communications (e.g., optical signals) via the optical fiber and the optical receiver and use those optical communications to generate and transmit electrical communications (e.g., electrical signals). However, specific optical transmitter subsystems and optical receiver subsystems have been described, one of skill in the art in possession of the present disclosure will appreciate how optical transmitter subsystems and/or optical receiver subsystems may include other configurations that will fall within the scope of the present disclosure as well.

In the specific examples provided below, the electrical/optical communication conversion aggregator system 600 is configured to couple to 64 NIC devices (e.g., each of the 8 NIC devices 406a-406h/500 of FIGS. 4 and 5 in each of the 8 server devices 304a-304h/400 of FIGS. 3 and 4), and thus will include 64 optical transmitter systems and 64 optical receiver systems (with each optical transmitter system having 4 optical transmitter subsystems and each optical receiver system having 4 optical receiver subsystems, and each of 64 optical transmitter system/optical receiver system pairs configured to handle the 4 transmit signals and 4 receive signals received from each NIC device 500 as described above), although one of skill in the art in possession of the present disclosure will appreciate how different numbers of optical transmitter systems and optical receiver systems (and/or different numbers of optical transmitter subsystems and optical receiver subsystems) may be provided in the electrical/optical communication conversion aggregator system 600 while remaining within the scope of the present disclosure as well.

In some examples, the optical transmitter systems 604-606 and/or the optical receiver systems 608-610 may be integrated into one or more common optical chips, packages, or material planar substrates that may be provided by silicon (also known as silicon photonics), silicon nitride, lithium niobate, thin film lithium niobate, indium phosphide, and/or other materials that would be apparent to one of skill in the art in possession of the present disclosure. For example, a single optical chip may be fabricated that integrates all of the optical transmitter systems 604-606 and all of the optical receiver systems 608-610. In another example, a first optical chip may integrate all of the optical transmitter systems 604-606, and a second optical chip may integrate all of the optical receiver systems 608-610.

To provide a specific example, respective optical chips may be fabricated to each include at least thirty-two of the optical transmitter subsystems included in the optical transmitter systems, and respective optical chips may be fabricated to each include at least thirty-two of the optical receiver subsystems included in the optical receiver systems. As will be appreciated by one of skill in the art in possession of the present disclosure, providing at least thirty-two optical transmitter subsystems or optical receiver subsystems on a common chip increases the optical transmission or optical receiving capabilities of the electrical/optical communication conversion aggregator system 600 beyond the conventional capabilities that are +enabled by conventional pluggable transceiver devices. However, as will be appreciated by one of skill in the art in possession of the present disclosure, different numbers and/or combinations of the optical transmitter systems 604-606 and/or the optical receiver systems 608-610 may be integrated into one or more common chips in order to realize the benefits discussed below while remaining within the scope of the present disclosure as well.

For example, one of skill in the art in possession of the present disclosure will appreciate how the integration of the optical transmitter systems 604-606 and/or the optical receiver systems 608-610 into one or more common chips as described above will provide economies of scale with regard to the integrated optics subsystems and silicon photonics subsystems utilized in the electrical/optical communication conversion aggregator system 600, will enable the use of a single relatively high-powered laser to supply silicon photonics modulators (i.e., rather than the use of one-laser-per-transceiver device in conventional systems), will enable the use of a single silicon V-grove array to couple optical fibers to the silicon photonics chip, as well as provide other benefits that would be apparent to one of skill in the art in possession of the present disclosure.

The chassis 602 may also house an aggregated networked device connector subsystem that, in the examples illustrated and discussed below, is provided by an aggregated NIC connector subsystem 612 that is configured to couple to NIC devices as described in further detail below. In a specific example, the aggregated NIC connector subsystem 612 may be provided by at least one RF connector that is configured to perform data transmission at 100G speeds using PAM4 with each of the 64 NIC devices that may be connected to the electrical/optical communication conversion aggregator system 600 as described above. In some examples, the aggregated NIC connector subsystem 612 may include a single high-density copper connector that is configured to connect to 64 NIC devices discussed above via a “breakout” type cable, although providing a plurality of connectors in the aggregated NIC connector subsystem 612 that are configured to connect to subsets of the 64 NIC devices discussed above via respective “breakout” type cables will fall within the scope of the present disclosure as well. As such, the aggregated NIC connector subsystem 612 may be provided by standardized pluggable modules, high-density off-board connectors, and/or other connectors that would be apparent to one of skill in the art in possession of the present disclosure. Furthermore, the aggregated NIC connector subsystem 612 may be configured to connect to one or more corresponding connectors on a backplane while remaining within the scope of the present disclosure as well.

As illustrated, a plurality of networked device connections may be provided by NIC connections 614 in the examples illustrated and described below and may extend from the aggregated NIC connector subsystem 612 and to an electrical path management subsystem 616 that couples those NIC connections 614 to the optical transmitter subsystems 604a-604d to 606a-606d in the optical transmitter systems 604 to 606, respectively, and to the optical receiver subsystems 608a-608d to 610a-610d in the optical receiver systems 608 to 610, respectively.

As will be appreciated by one of skill in the art in possession of the present disclosure, the example of FIG. 6A illustrates 64 NIC connections 614 that extend from the aggregated NIC connector subsystem 602 and that may each be coupled to one of the 64 NIC devices that may couple to the electrical/optical communication conversion aggregator system 600 as described herein. Furthermore, as discussed above with reference to FIG. 5, each NIC device 500 may be configured to transmit four transmit signals and receive four receive signals via its coupling to the electrical/optical communication conversion aggregator system 600, and thus each NIC connection 614 is configured to convey four transmit signals and four receive signals for its connected NIC device. As such, one of skill in the art in possession of the present disclosure will appreciate how the electrical/optical communication conversion aggregator system 600 in the illustrated embodiment includes an electrical path management subsystem 616 that is configured to electrically route four transmit signals received from each NIC connection 614 to a respective one of the optical transmitter systems 604-606, and is configured to electrically route four receive signals to each NIC connection 614 from a respective one of the optical receiver systems 608-610.

To provide a specific example, for a “first” NIC connection 614 that is configured to convey four transmit signals and four receive signals for its connected NIC device, the electrical path management subsystem 614 may be configured to electrically route those four transmit signals to the respective optical transmitter subsystems 604a-604d in the optical transmitter system 604, and may be configured to electrically route those four receive signals from the respective optical receiver subsystems 608a-608d in the optical receive system 608 to that “first” NIC connection 614. Similarly, for a “last” NIC connection 614 that is configured to convey four transmit signals and four receive signals for its connected NIC device, the electrical path management subsystem 614 may be configured to electrically route those four transmit signals to the respective optical transmitter subsystems 606a-606d in the optical transmitter system 606, and may be configured to electrically route those four receive signals from the respective optical receiver subsystems 610a-610d in the optical receive system 610 to that “last” NIC connection 614.

As such, one of skill in the art in possession of the present disclosure will appreciate how the electrical path management subsystem 616 may be provided using any electrical connection routing techniques that are configured to receive the NIC connections 614, electrically route the transmit signals from each of those NIC connections 614 to the optical transmitter systems 604-606 as described above, and electrically route the receive signals from optical receiver systems 608-610 to those NIC connections 614 as described above, and in many embodiments may be provided using any of a variety of passive routing techniques known in the art.

As illustrated, the chassis 602 includes a plurality of networking device connectors that, in the examples illustrated and described below, are provided by switch device connectors 618a, 618b, 618c, and up to 618d. Continuing with the specific examples provided above in which the electrical/optical communication conversion aggregator system 600 couples to 64 NIC devices, the chassis 602 may include 64 switch device connectors 618a-618d that are configured to couple to optical cables as described below, although different numbers of switch device connectors will fall within the scope of the present disclosure as well. For example, in some embodiments the switch devices connectors 618a-618d may be provided by 16 thirty-two fiber Multi-Fiber Push-on (MPO-32) connectors, thirty-two MPO-16 connectors, Multi-fiber Miniature Connector (MMC) connectors, and/or other connectors known in the art.

Each switch device connector 618a-618d may be coupled to a respective optical transmitter system/optical receiver system pair provided using the optical transmitter systems 604/606 and optical receiver systems 608-610. For example, with reference to FIG. 6B, the “first” switch device connector 618a may be coupled to each of the optical transmitter subsystems 604a-604d in the optical transmitter system 604 via optical connections, and may be coupled to each of the optical receiver subsystems 608a-608d in the optical receiver system 608 via optical connections (thus coupling the switch device connector 618a to the “first” NIC connection 614 in the example above). In another example, with reference to FIG. 6C, the “last” switch device connector 618d may be coupled to each of the optical transmitter subsystems 606a-606d in the optical transmitter system 606 via optical connections, and may be coupled to each of the optical receiver subsystems 610a-610d in the optical receiver system 610 via optical connections (thus coupling the switch device connector 618d to the “last” NIC connection 614 in the example above).

While a specific connectivity configuration for the optical transmitter system/optical receiver system pairs 604/608 and 606/610 to the switch device connectors 618a and 618d, respectively, has been described, other connectivity configurations will fall within the scope of the present disclosure as well. For example, one of skill in the art in possession of the present disclosure will appreciate how the optical transmitter subsystems in any particular optical transmitter system may be connected to different switch device connectors (e.g., the optical transmitter subsystem 604a in the optical transmitter system 604 may be connected to the switch device connector 618a, the optical transmitter subsystem 604b in the optical transmitter system 604 may be connected to the switch device connector 618b, and so on). Similarly. the optical receiver subsystems in any particular optical receiver system may be connected to different switch device connectors (e.g., the optical receiver subsystem 608a in the optical receiver system 608 may be connected to the switch device connector 618a, the optical receiver subsystem 608b in the optical receiver system 608 may be connected to the switch device connector 618b, and so on). As such, optical transmitter subsystems and optical receiver subsystems in any particular optical transmitter system and optical receiver system, respectively, may be connected to different switch devices.

As will be appreciated by one of skill in the art in possession of the present disclosure, the electrical path management subsystem 616 and its connections to the switch device connectors 618a-618d provided via the optical transmitter systems 604-606 and optical receiver systems 608-610 may be configured to optimize and simplify the physical connectivity and cable management to both the networking devices and the networked devices similarly as is provided by the optical cable “shuffle” harnesses described herein, or may be utilized with the optical cable “shuffle” harnesses described herein to reduce the complexity and costs of such optical cable “shuffle” harnesses. However, while a specific electrical/optical communication conversion aggregator system 600 has been illustrated and described, one of skill in the art in possession of the present disclosure will recognize that electrical/optical communication conversion aggregator systems (or other devices operating according to the teachings of the present disclosure in a manner similar to that described below for the electrical/optical communication conversion aggregator system 600) may include a variety of components and/or component configurations for providing conventional functionality, as well as the electrical/optical communication conversion aggregator functionality discussed below, while remaining within the scope of the present disclosure as well.

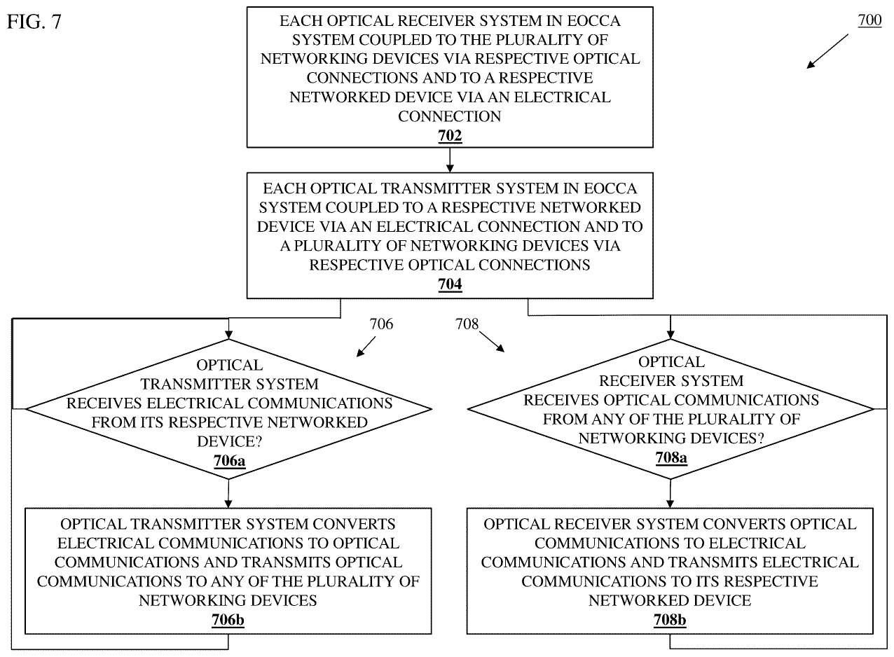

Referring now to FIG. 7, an embodiment of a method 700 for aggregating the conversion between electrical communications and optical communications is illustrated. As discussed below, the systems and methods of the present disclosure aggregate the conversion between electrical communications and optical communications transmitted between a plurality of networked devices and a plurality of networking devices. For example, a networked system provided according to the teachings of the present disclosure may include networking devices, networked devices, and an electrical/optical communication conversion aggregator system. A chassis of the electrical/optical communication conversion aggregator system houses optical transmitter systems that are each coupled to a respective one of the networked devices via a respective electrical connection and to each of the networking devices via a respective optical connection, and optical receiver systems that are each coupled to each of the networking devices via a respective optical connection and to a respective one of the networked devices via a respective electrical connection. Each optical transmitter system converts electrical communications received from its connected networked device to optical communications that it transmits to any of its connected networking devices, and each optical receiver system converts optical communications received from any of its connected networking devices to electrical communications that it transmits to its connected networked device. As discussed below, the electrical/optical communication conversion aggregator system of the present disclosure reduces costs (e.g., via the manufacturing of a single 256-transceiver-functionality-provisioning assembly rather than the provisioning of sixty-four 4-transceiver-functionality-provisioning assemblies), simplifies power management and cooling, and provides other benefits over conventional systems that use conventional transceiver devices with each of the networked devices.

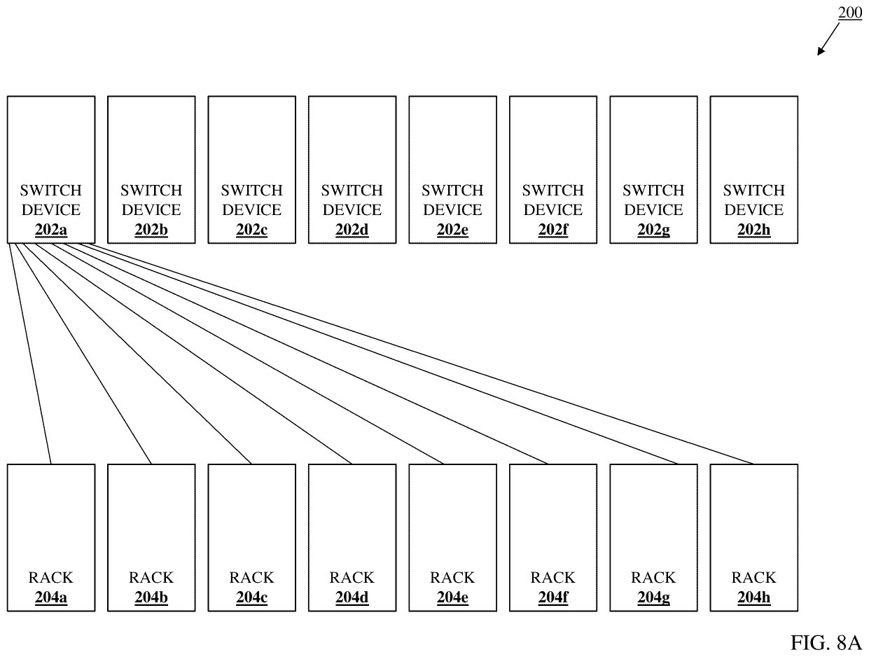

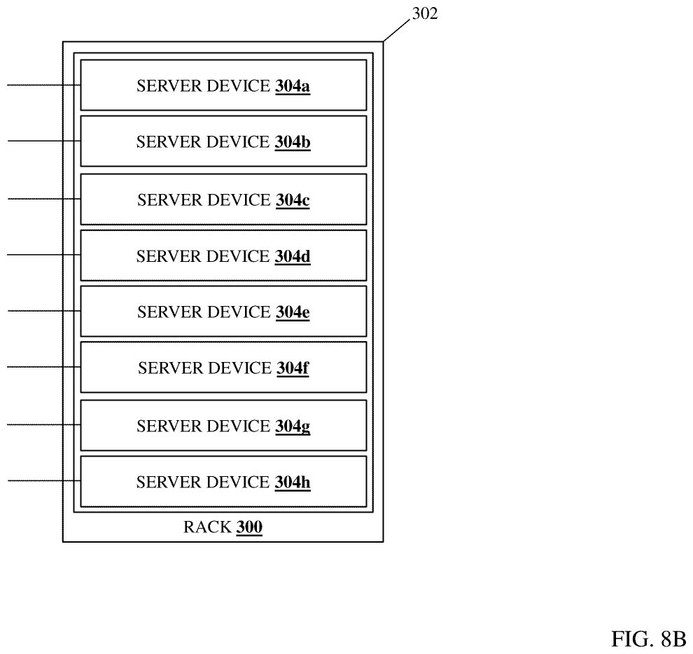

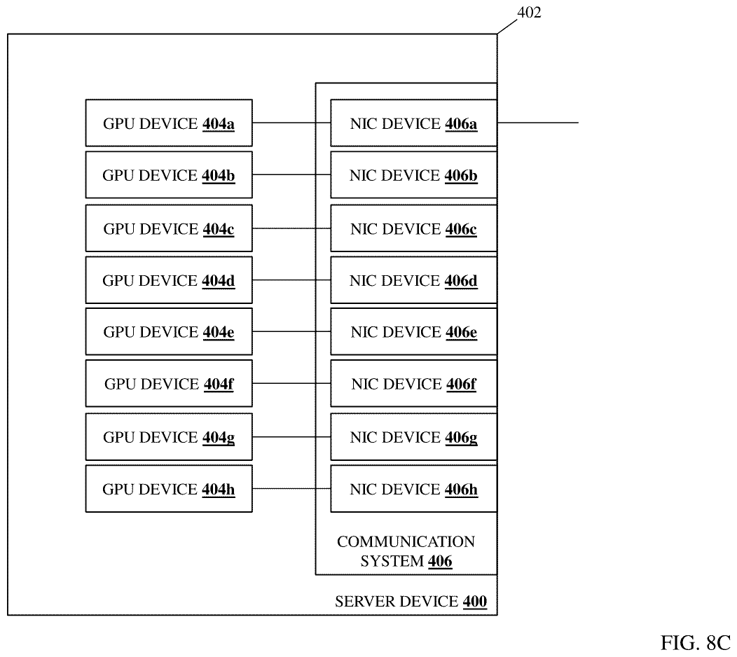

As will be appreciated by one of skill in the art in possession of the present disclosure, an Artificial Intelligence (AI) fabric provided using the GPU devices 404a-404h in each of the server devices 304a-304h/400 included in each of the racks 204a-204h/300 may require connectivity between each of those GPU devices 404a-404h, and an example of such connectivity is provided below. With reference to FIGS. 8A, 8B, and 8C, the switch device 202a may be connected to the “first” NIC device 406a in each of the server devices 304a-304h/400 included in each of the racks 204a-204h/300 (with each connection represented in FIG. 8A by a respective line between the switch device 202a and one of the racks 204a-204h that includes 8 cables that each connect to the “first” NIC device 406a in a respective one of the server devices 304a-304h in that rack).

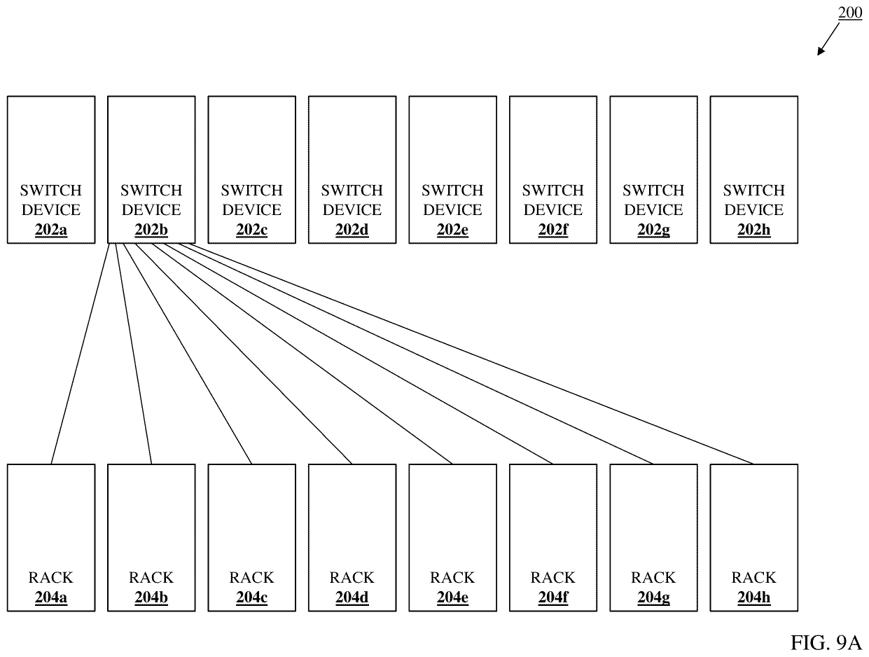

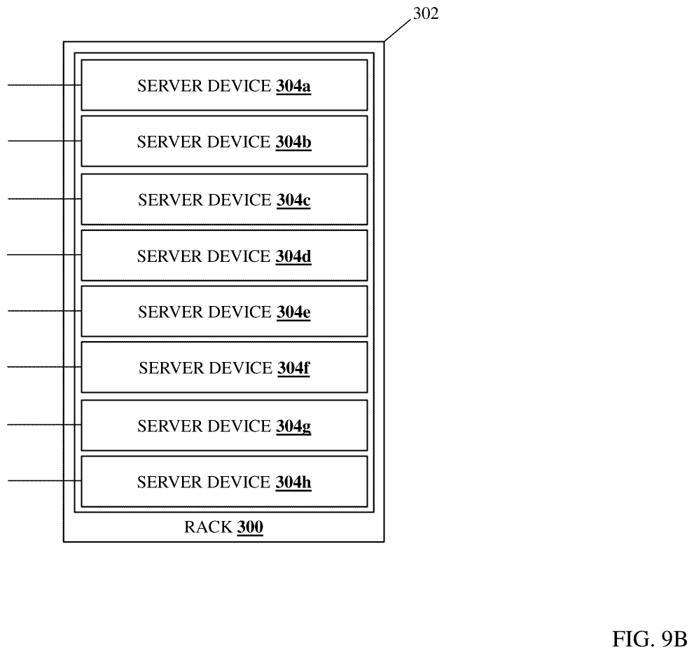

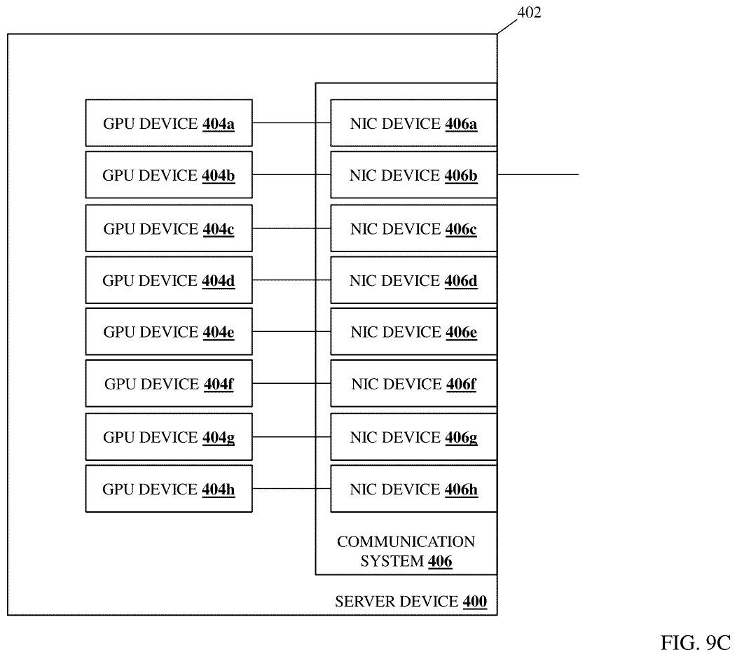

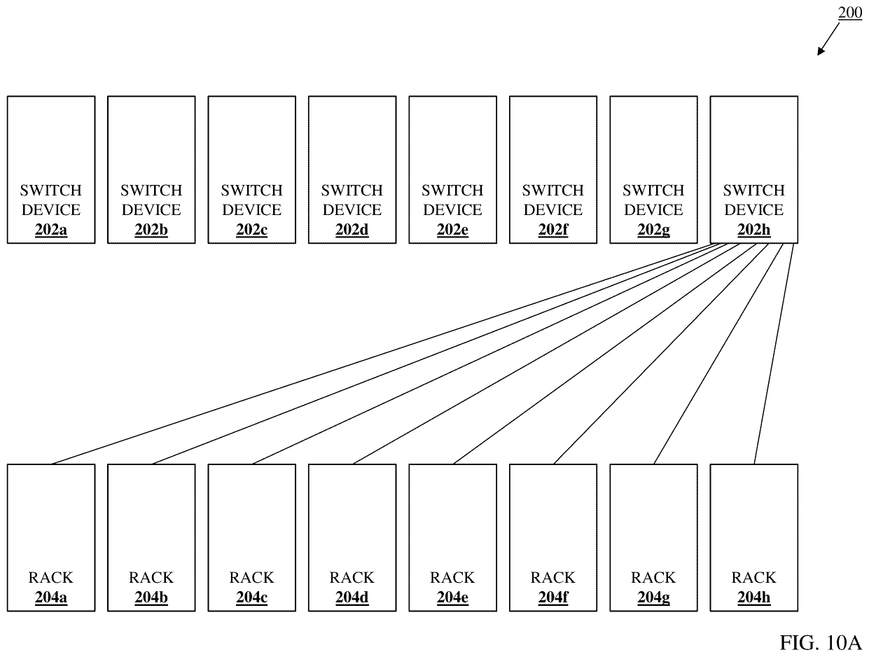

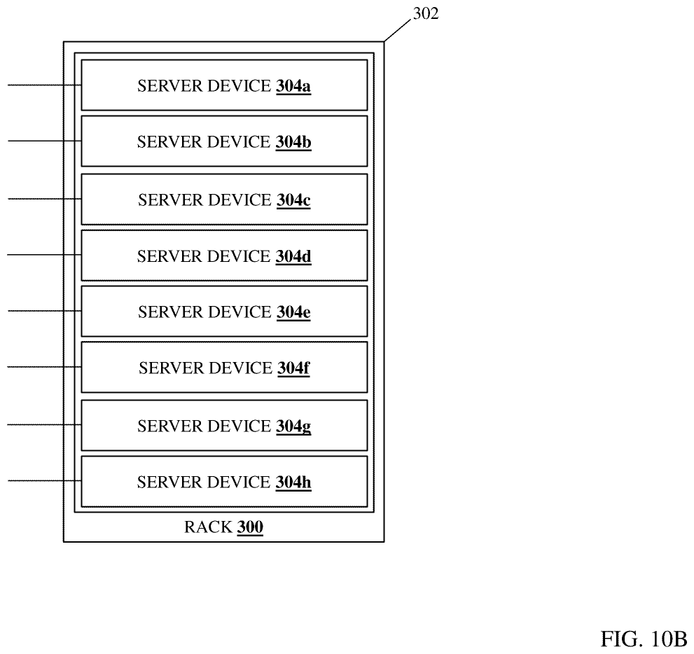

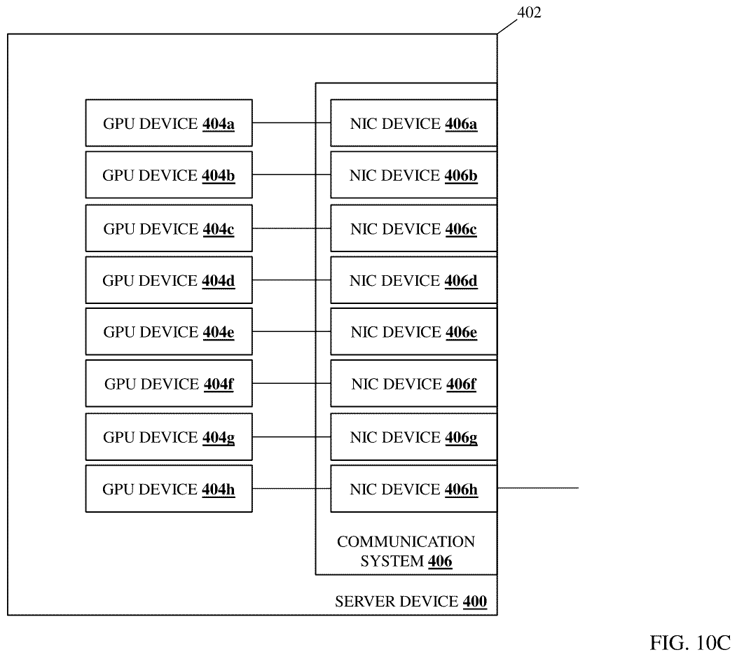

Similarly, with reference to FIGS. 9A, 9B, and 9C, the switch device 202b may be connected to the “second” NIC device 406b in each of the server devices 304a-304h/400 included in each of the racks 204a-204h/300 (with each connection represented in FIG. 9A by a respective line between the switch device 202b and one of the racks 204a-204h that includes 8 cables that each connect to the “second” NIC device 406b in a respective one of the server devices 304a-304h in that rack). Similarly as well, with reference to FIGS. 10A, 10B, and 10C, the switch device 202h may be connected to the “last” NIC device 406h in each of the server devices 304a-304h/400 included in each of the racks 204a-204h/300 (with each connection represented in FIG. 10A by a respective line between the switch device 202h and one of the racks 204a-204h that includes 8 cables that each connect to the “last” NIC device 406h in a respective one of the server devices 304a-304h in that rack), and one of skill in the art in possession of the present disclosure will recognize how the switch devices 202c-202g may be connected to NIC devices in the racks 204a-204h similarly as the switch devices 202a, 202b, and 202h described above.

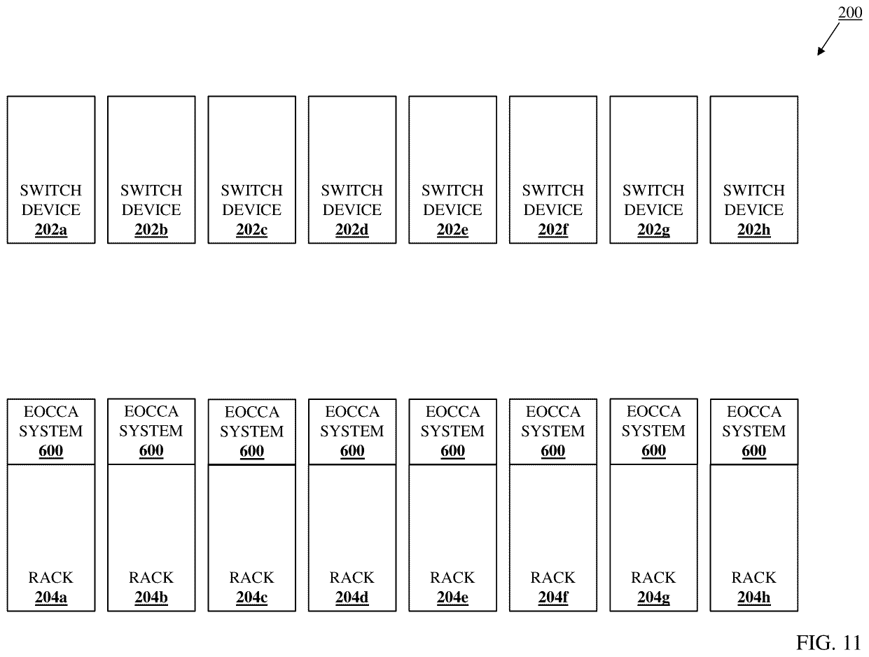

With reference to FIG. 11, a respective Electrical/Optical Communication Conversion Aggregator (EOCCA) system 600 may be provided for use with each of the racks 204a-204h in the networked system 200 in order to provide the connectivity described above with reference to FIGS. 8A-8C, 9A-9C, and 10A-10C. As discussed above, each electrical/optical communication conversion aggregator system 600 may be housed in a respective rack 204a-204h/300 with its server devices 304a-304h and cabled to those server devices as described in further detail below, and one of skill in the art in possession of the present disclosure will appreciate how some embodiments may provide for the housing of the electrical/optical communication conversion aggregator system 600 at a “midpoint” in a rack (e.g., between the server devices 304d and 304e), as well as the use of a plurality of different length cabling that is configured to cable the server devices 304a-304h to the electrical/optical communication conversion aggregator system 600 in order to efficiently connect the server devices 304a-304h to the electrical/optical communication conversion aggregator system 600 with minimal cable lengths and cabling obstructions (e.g., via the use of cables with cable lengths that minimize the need for managing “slack” lengths of cable).

As will be appreciated by one of skill in the art in possession of the present disclosure, the positioning of the electrical/optical communication conversion aggregator system 600 relative to the server devices to which it is connected must satisfy maximum copper cable length thresholds (e.g., approximately 2 meters) to ensure that communications transmitted via those copper cables do not degrade more than a threshold amount that would prevent the utilization of the linear optics described below.

However, while described as being housed in the rack with the server devices to which it is connected, one of skill in the art in possession of the present disclosure will appreciate how the electrical/optical communication conversion aggregator system 600 may be housed outside of the rack that houses the server devices to which it is connected while remaining within the scope of the present disclosure as well. Furthermore, one of skill in the art in possession of the present disclosure will appreciate how multiple racks may share a single electrical/optical communication conversion aggregator system 600, or a single rack may be provided with multiple electrical/optical communication conversion aggregator systems 600, while remaining within the scope of the present disclosure as well.

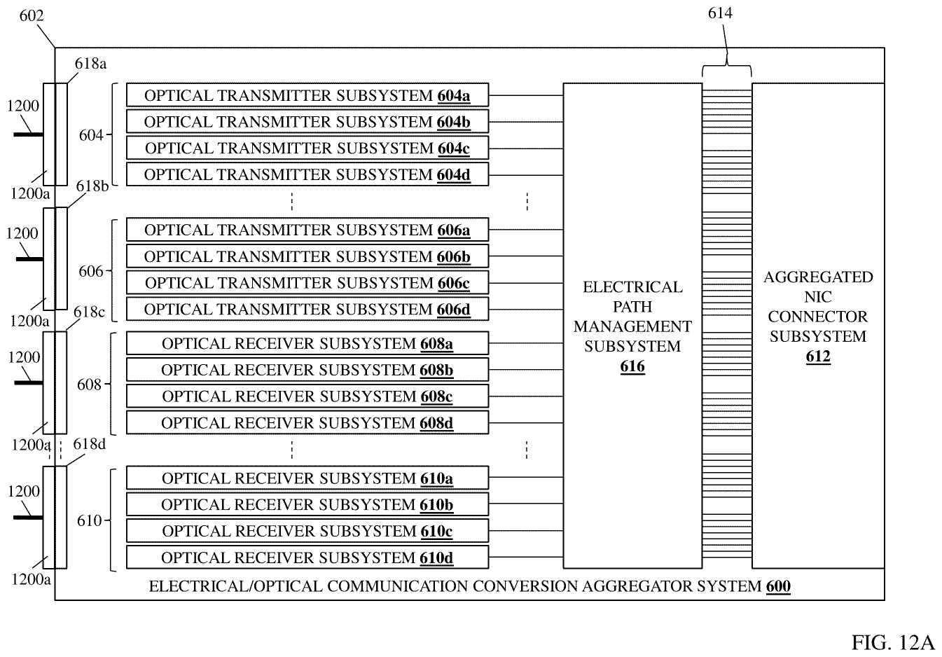

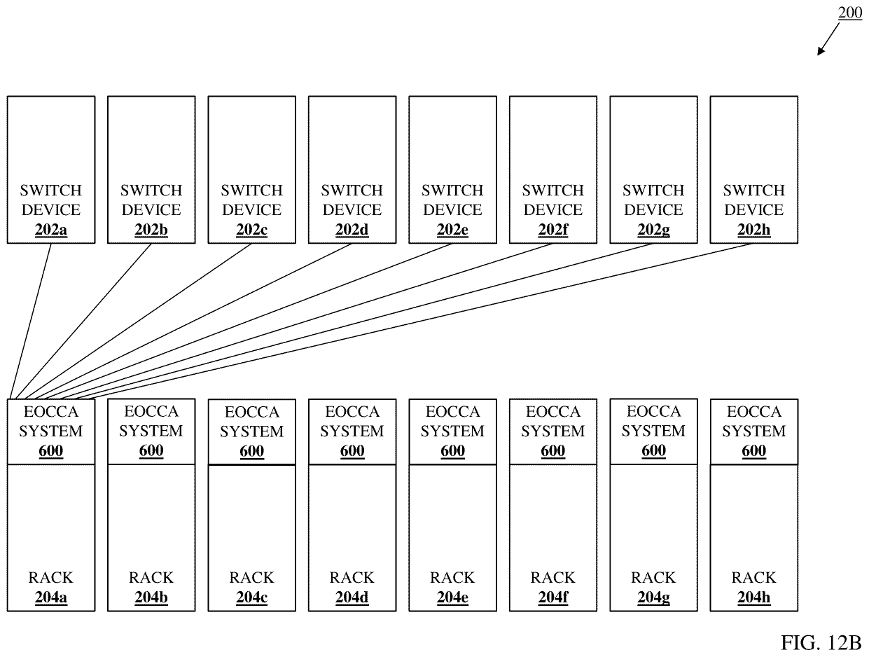

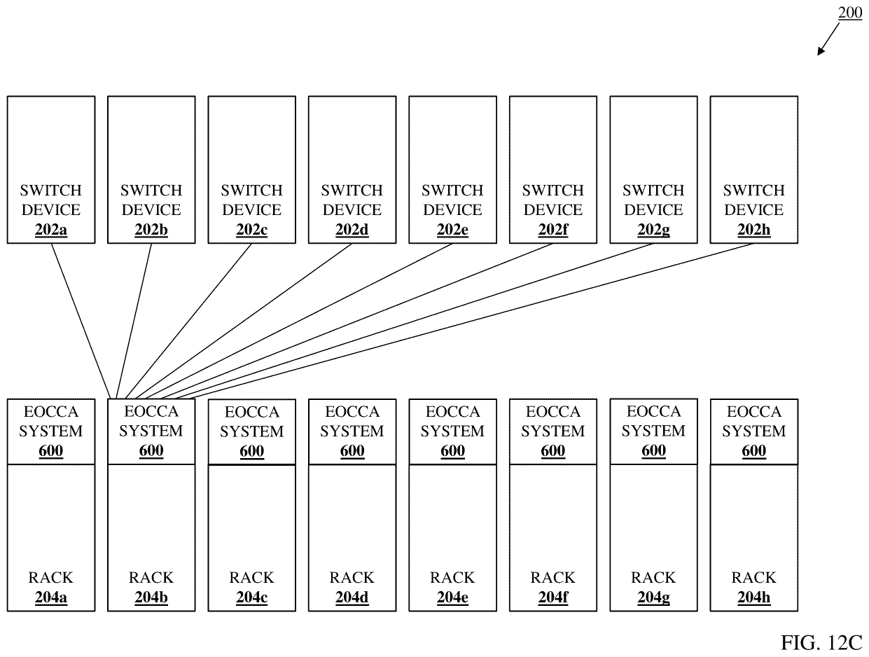

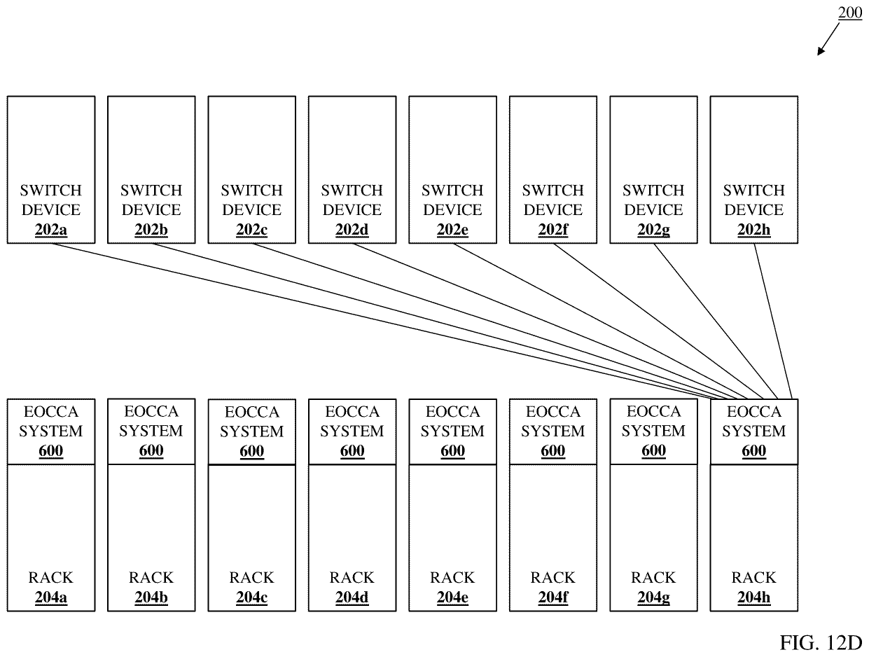

With reference to FIG. 12A, in an embodiment of block 702, a respective optical cable 1200 (e.g., including single-mode or multi-mode optical fibers) may be connected to each of the switch device connectors 618a-618d on the electrical/optical communication conversion aggregator system 600 via an optical cable connector 1200a on that optical cable 1200. Thus, continuing with the example above in which each electrical/optical communication conversion aggregator system 600 includes 64 switch device connectors 618a-618d, 64 optical cables 1200 may be coupled to the electrical/optical communication conversion aggregator system 600 in FIG. 11.

However, in embodiments in which the switch devices connectors 618a-618d are provided by 16 MPO-32 connectors as described above, each of the switch devices 202a-202h may include 32 Multi-Fiber Push-on 16 (MPO-16) connectors connected to respective optical cables, with the optical cables that are connected to the switch devices 202a-202h provided in an optical cable “shuffle” harness that routes two optical fibers from each switch device 202a-202h for connection to two of the 16 MPO-32 connectors on each of the 8 electrical/optical communication conversion aggregator systems 600. As such, one of skill in the art in possession of the present disclosure will appreciate how the electrical/optical communication conversion aggregator system 600 may be coupled to the networking devices in a variety of manners that will fall within the scope of the present disclosure.

With reference to FIG. 12B, the optical cables 1200 connected to the electrical/optical communication conversion aggregator system 600 that is provided for the “first” rack 204a may then be coupled to each of the switch devices 202a-202h, and one of skill in the art in possession of the present disclosure will appreciate how each connection that is represented by a respective line between the electrical/optical communication conversion aggregator system 600 provided for the “first” rack 204a and the switch devices 202a-202h in FIG. 12B is provided by 8 optical fibers in each of the optical cables 1200 that may each connect to that switch device (e.g., totaling 8 connections on that switch device that are each connected to one of those 8 optical fibers).

Similarly, with reference to FIG. 12C, the optical cables 1200 connected to the electrical/optical communication conversion aggregator system 600 that is provided for the “second” rack 204b may then be coupled to each of the switch devices 202a-202h, and one of skill in the art in possession of the present disclosure will appreciate how each connection that is represented by a respective line between the electrical/optical communication conversion aggregator system 600 provided for the “second” rack 204b and the switch devices 202a-202h in FIG. 12C is provided by 8 optical fibers in each of the optical cables 1200 that may each connect to that switch device (e.g., totaling 8 connections on that switch device that are each connected to one of those 8 optical fibers).

Similarly as well, with reference to FIG. 12D, the optical cables 1200 connected to the electrical/optical communication conversion aggregator system 600 that is provided for the “last” rack 204h may then be coupled to each of the switch devices 202a-202h, and one of skill in the art in possession of the present disclosure will appreciate how each connection that is represented by a respective line between the electrical/optical communication conversion aggregator system 600 provided for the “last” rack 204h and the switch devices 202a-202h in FIG. 12D is provided by 8 optical fibers in each of the optical cables 1200 that may each connect to that switch device (e.g., totaling 8 connections on that switch device that are each connected to one of those 8 optical fibers). Furthermore, while not illustrated or described in detail, one of skill in the art in possession of the present disclosure will appreciate how the electrical/optical communication conversion aggregator systems 600 provided for the racks 204c-204g may be connected to the switch devices 202a-202h similarly as the electrical/optical communication conversion aggregator systems 600 provided for the racks 204a, 204b, and 204h described above.

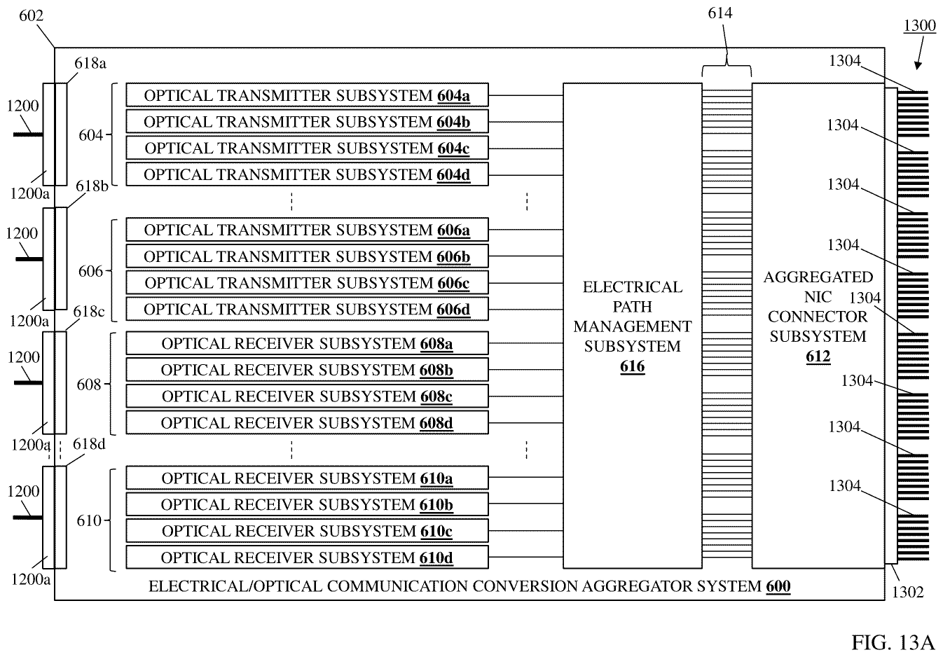

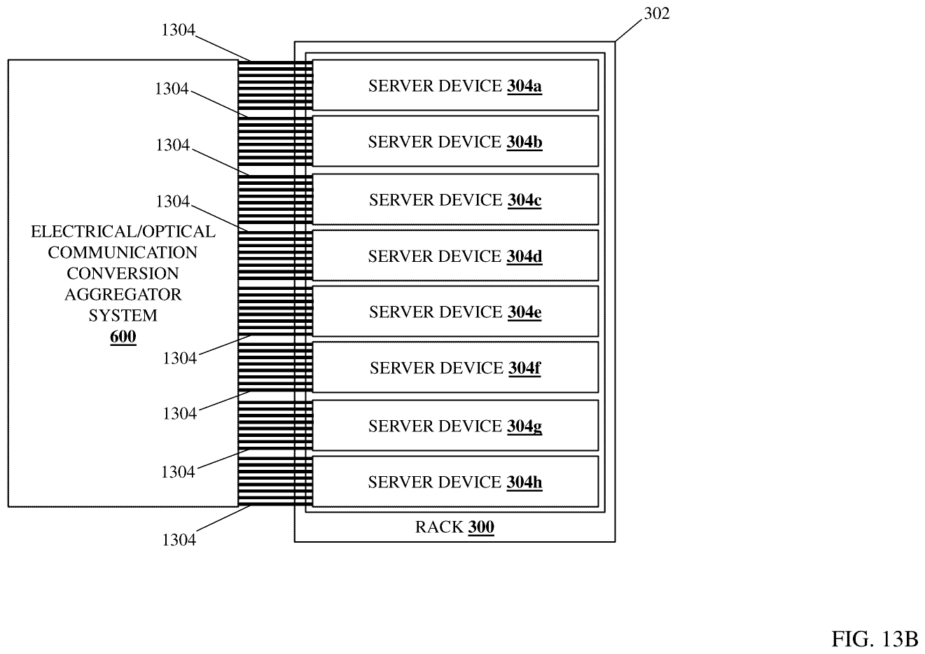

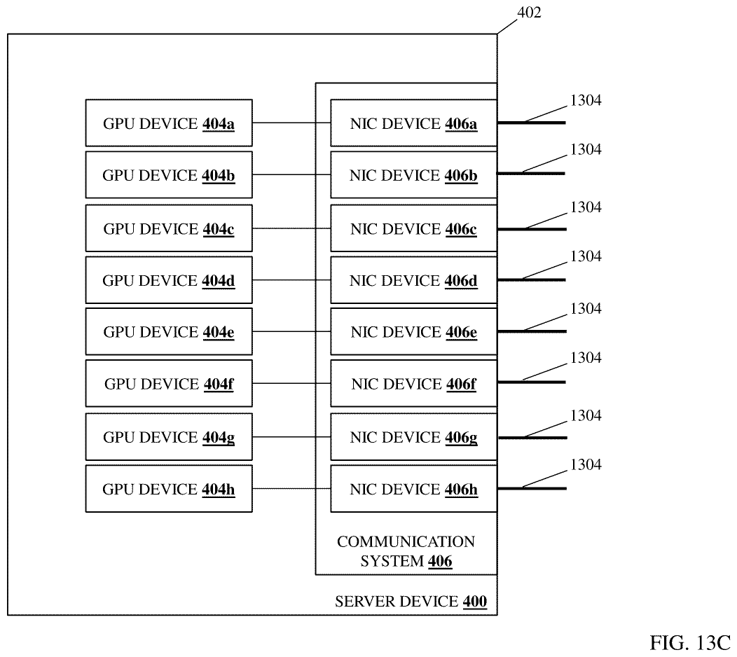

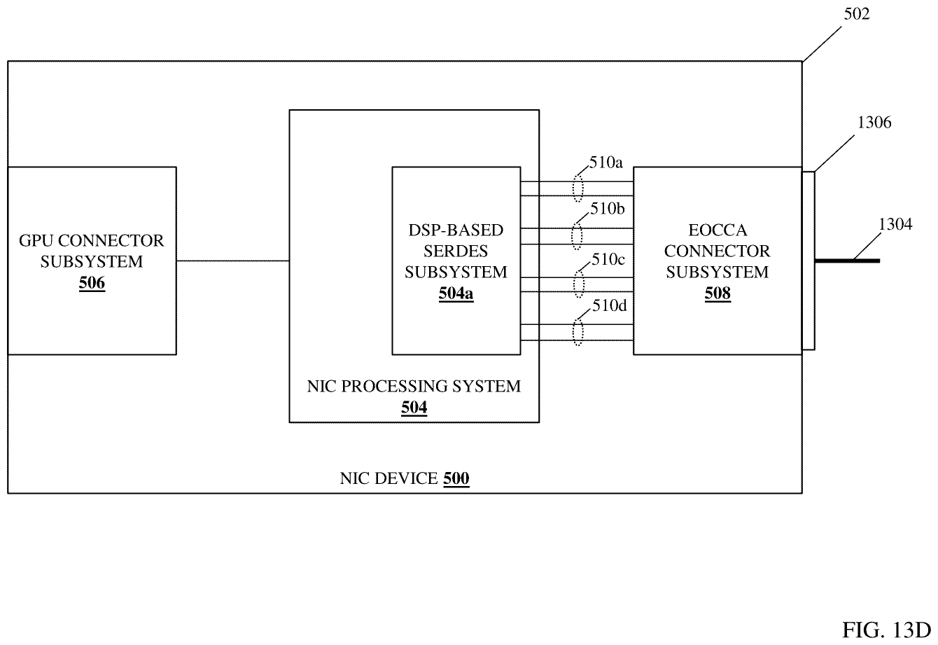

With reference to FIG. 13A, an aggregated networked device cabling system, which in the examples illustrated and described below is provided by an aggregated NIC cabling system 1300, is connected to the aggregated NIC connector subsystem 612 on the electrical/optical communication conversion aggregator system 600 via an aggregated NIC connector 1302. In the illustrated examples, the aggregated NIC cabling system 1300 is a “breakout” type cabling system that includes a plurality of electrical cables 1304 (e.g., 64 electrical cables in the illustrated example that may each be provided by a passive copper twinax cable) that extend from the single aggregated NIC connector 1302. However, as described above the aggregated NIC connector subsystem 612 may be provided by a plurality of connectors, and in such situations a plurality of aggregated NIC cabling systems that are similar to the aggregated NIC cabling system 1300 (but with fewer electrical cables) may be connected to each of the connectors included in the aggregated NIC connector subsystem 612 while remaining within the scope of the present disclosure as well. As illustrated in FIGS. 13B, 13C, and 13D, each of the electrical cables 1304 extending from the aggregated NIC cabling system 1300 on an electrical/optical communication conversion aggregator system 600 provided with a rack may connect via its respective connector 1306 to the EOCCA connector subsystem 508 on each NIC device 406a-406h/500 included in each server device 304a-304h/400 in that rack.

The method 700 may begin at block 702 where each optical receiver system in an Electrical/Optical Communication Conversion Aggregator (EOCCA) system is coupled to a plurality of networking devices via respective optical connections and to a respective networked device via an electrical connection. As will be appreciated by one of skill in the art in possession of the present disclosure, the coupling of the electrical/optical communication conversion aggregator systems 600 to the switch devices 202a-202h via the optical cables 1200 as described above with reference to FIGS. 12A-12D operates at block 702 to couple each optical receiver system 608-610 in the electrical/optical communication conversion aggregator systems 600 to the switch devices 202a-202h via the optical cables 1200.

As will be appreciated by one of skill in the art in possession of the present disclosure, the coupling of each electrical/optical communication conversion aggregator system 600 provided for a rack to each NIC device 406a-406h/500 in each server device 304a-304h/400 in that rack as described above with reference to FIGS. 13A-13D operates at block 702 to couple each optical receiver system 608-610 in that electrical/optical communication conversion aggregator system 600 to one of those NIC devices via one of the electrical cables 1304.

The method 700 then proceeds to block 704 where each optical transmitter system in the EOCCA system is coupled to a respective networked device via an electrical connection and to a plurality of networking devices via respective optical connections. As will be appreciated by one of skill in the art in possession of the present disclosure, the coupling of each electrical/optical communication conversion aggregator system 600 provided for a rack to each NIC device 406a-406h/500 in each server device 304a-304h/400 in that rack as described above with reference to FIGS. 13A-13D operates at block 704 to couple each optical transmitter system 604-606 in that electrical/optical communication conversion aggregator system 600 to one of those NIC devices via one of the electrical cables 1304.

As will be appreciated by one of skill in the art in possession of the present disclosure, the coupling of the electrical/optical communication conversion aggregator systems 600 to the switch devices 202a-202h via the optical cables 1200 as described above with reference to FIGS. 12A-12D operates at block 704 to couple each optical transmitter system 604-606 in the electrical/optical communication conversion aggregator systems 600 to the switch devices 202a-202h via the optical cables 1200.

The method 700 may then proceed to both loop 706 where the EOCCA system provides communications transmitted from the networked devices to the networking devices, and loop 708 where the EOCCA system provides communications transmitted from the networking devices to the networked devices, and one of skill in the art in possession of the present disclosure will appreciate how the loops 706 and 708 may be performed simultaneously.

With reference first to loop 706, following block 704 the method 700 may proceed to decision block 706a where the method 700 proceeds depending on whether an optical transmitter system receives electrical communications from its respective networked device. As will be appreciated by one of skill in the art in possession of the present disclosure, any of the GPU devices 404a-404h in any of the server devices 304a-304h/400 may use its connected NIC device 406a-406h (i.e., the networked device in this example) to transmit an electrical communication via the electrical cable 1304 connected to that NIC device and to the electrical/optical communication conversion aggregator systems 600 such that it is received by the one of the optical transmitter systems 604-606 that this connected to that NIC device via the aggregated NIC connector subsystem 612 and the electrical path management subsystem 616. If, at decision block 706a, no optical transmitter system receives electrical communications from its respective networked device, the method 700 returns to decision block 706a in the loop 706. As such, the method 700 may perform the loop 706 until an optical transmitter system receives electrical communications from its respective networked device.

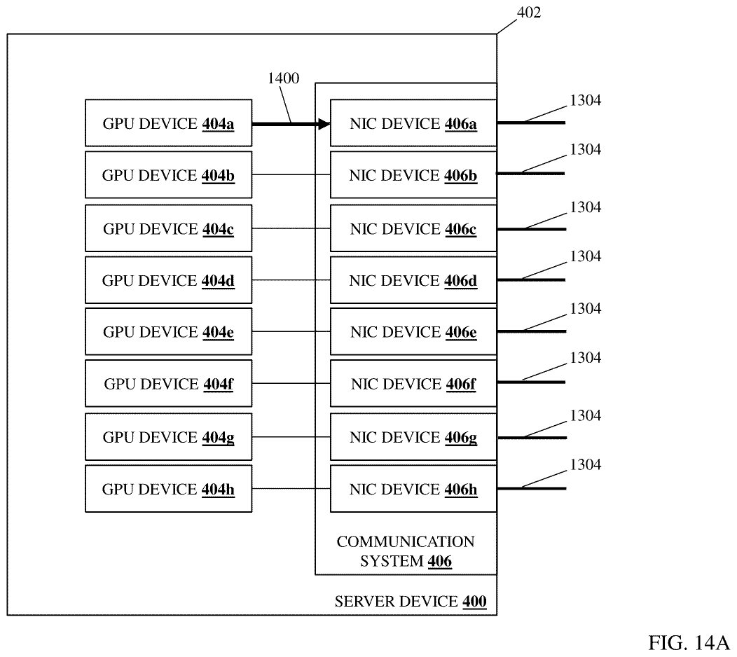

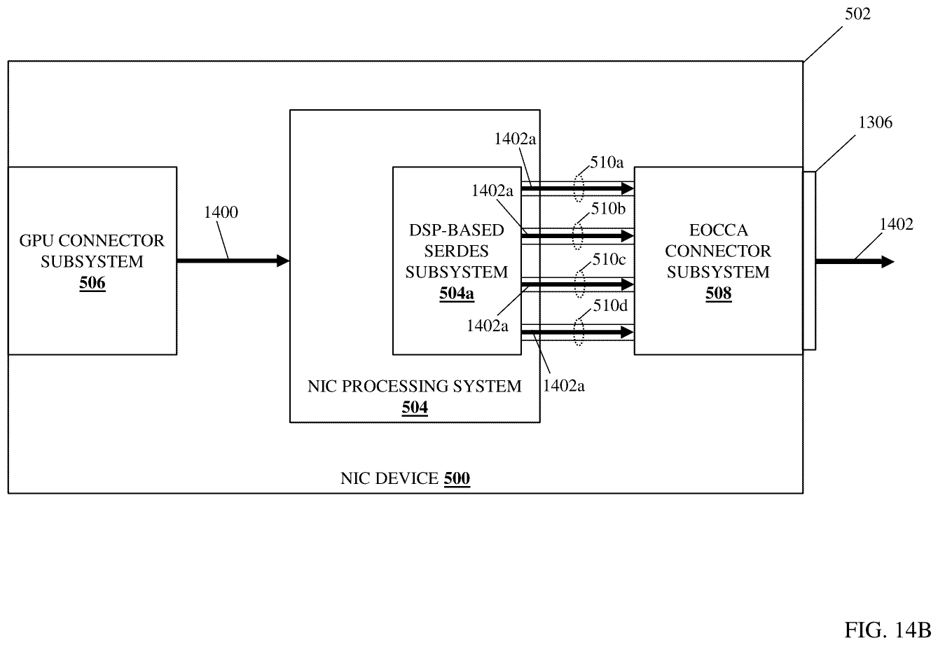

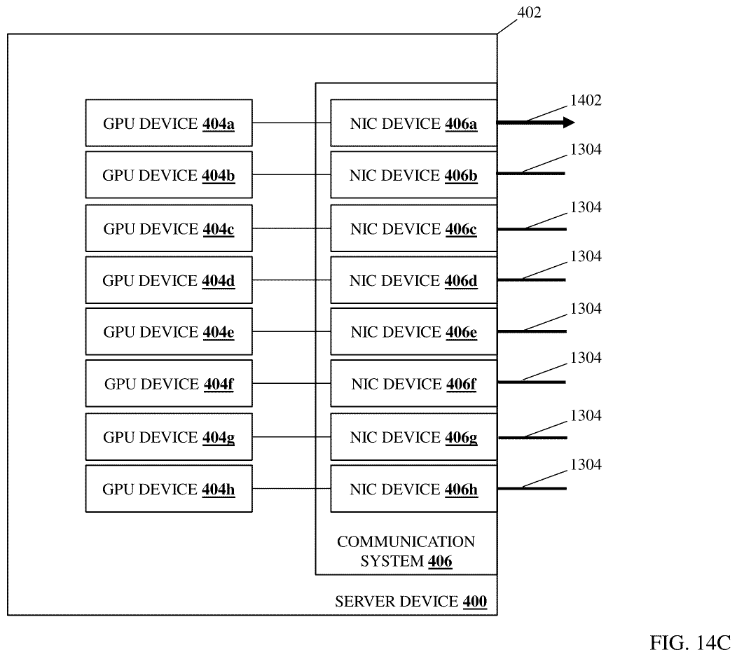

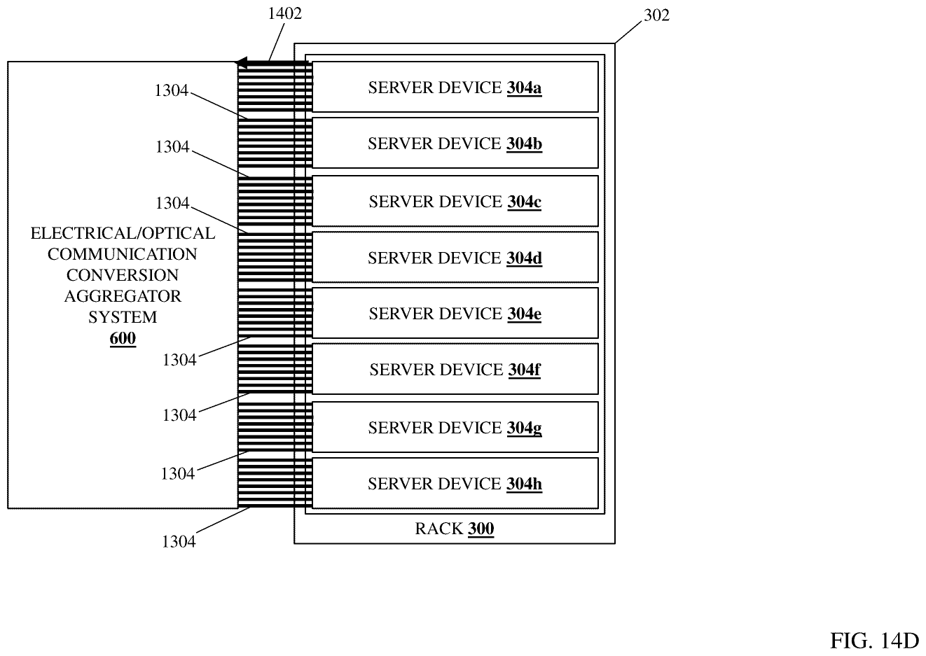

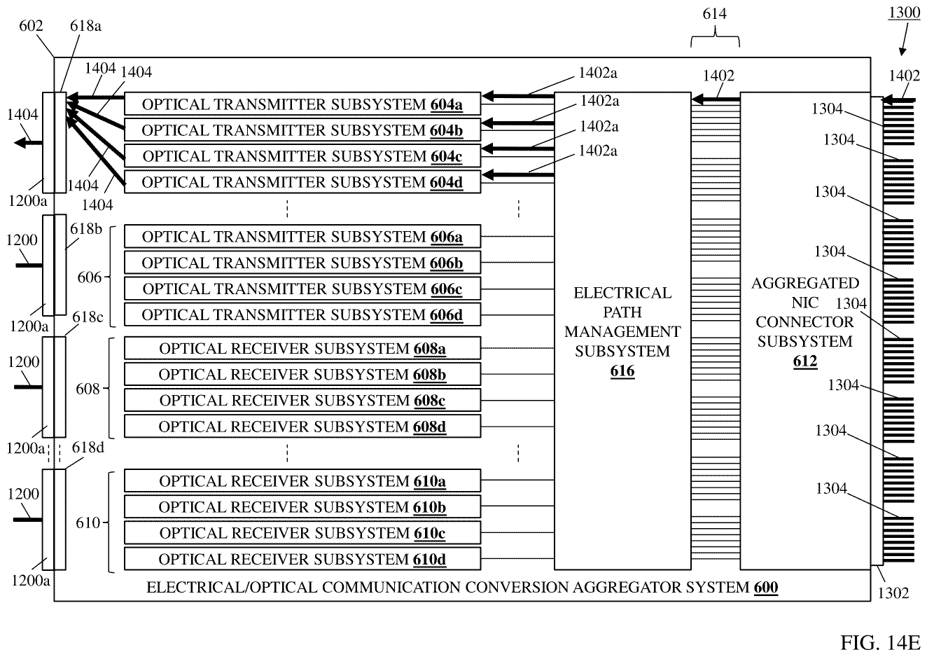

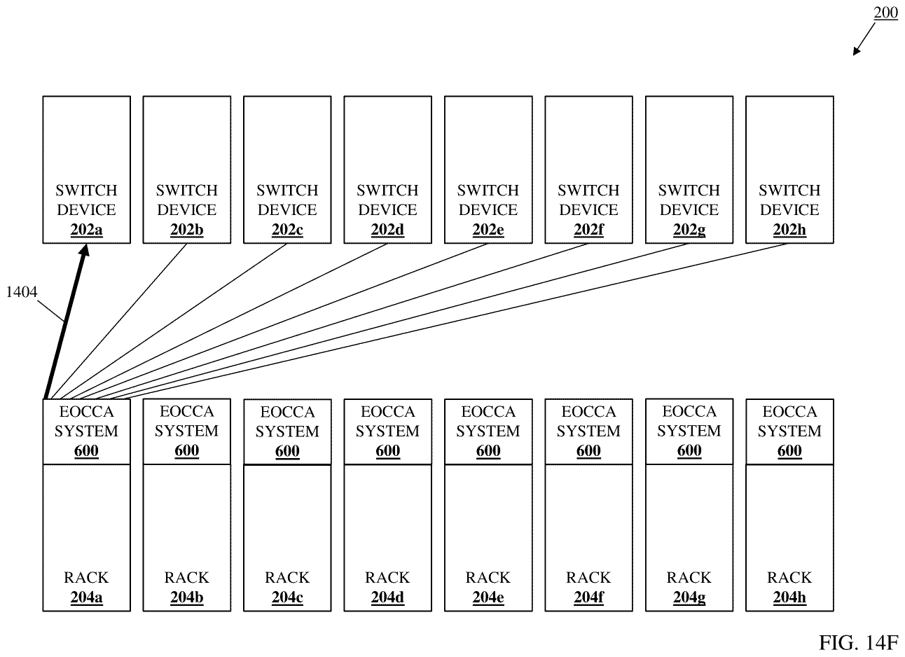

If, at decision block 706a, an optical transmitter system receives electrical communications from its respective networked device, the method 700 proceeds to block 706b in the loop 706 where the optical transmitter system converts the electrical communications to optical communications and transmits the optical communications to any of the plurality of networking devices. To provide a specific example, with reference to FIGS. 14A and 14B, the GPU device 404a in the server device 304a/400 included in the rack 204a/300 may perform electrical communication provisioning operations 1400 that include generating an electrical communication and transmitting that electrical communication to the NIC device 406a/500 such that the NIC processing system 504 receives that electrical communication via the GPU connector subsystem 506.

With continued reference to FIG. 14B, the DSP-based SERDES subsystem 504a in the NIC processing system 504 may then perform electrical communication transmission operations 1402 that include transmitting the electrical communication received from the GPU device 404a via the EOCCA connector subsystem 508 and the electrical cable 1304, with that electrical communication including four transmit signals 1402a provided via the transmit connection provided in each of the differential pair connections 510a-510d. As can be seen in FIGS. 14C, 14D, and 14E, the electrical communication transmission operations 1402 result in the electrical communication being transmitted to the electrical/optical communication conversion aggregator systems 600 such that it is received at the aggregated NIC connector subsystem and provided to the electrical path management subsystem 616. With continued reference to FIG. 14E, the electrical path management subsystem 616 may then perform electrical communication routing operations that include routing the four transmit signals 1402a provided by the NIC device 406a/500 in the electrical communication transmitted via the electrical communication transmission operations 1402 to the respective optical transmitter subsystems 604a-604d in the optical transmitter system 604.

As such, at decision block 706a, the optical transmitter system 604 in the electrical/optical communication conversion aggregator system 600 provided for the rack 204a may receive the electrical communication from the NIC device 406a/500 in the server device 304a/400 included in the rack 204a/300. With reference to FIGS. 14E and 14F, at block 706b, the optical transmitter system 604 in the electrical/optical communication conversion aggregator system 600 provided for the rack 204a may then perform electrical-to-optical communication conversion operations 1404 that may include using the analog linear electronic driver in each of the optical transmitter subsystems 604a-604d to receive a respective one of the four transmit signals included in those electrical communications and use that transmit signal to drive the optical transmitter in that optical transmitter subsystem to transmit optical communications (e.g., four optical transmit signals) via the optical fiber in that optical transmitter subsystem. As can be seen, the transmission of the optical communications by the optical transmitter system 604 as part of the electrical-to-optical communication conversion operations 1404 may include transmitting those optical communications via the switch device connector 618a, via the optical cable 1200 connected to the switch device connector 618a by its optical cable connector 1200a, and to the switch device 202a.

However, as discussed above, the optical transmitter subsystems in any particular optical transmitter system may be connected to different switch device connectors and, thus, different switch devices. As such, the electrical-to-optical communication conversion operations 1404 discussed above may include the optical transmitter subsystem 604a transmitting its optical communications via the switch device connector 618a, the optical transmitter subsystem 604b transmitting its optical communications via the switch device connector 618b, and so on. As will be appreciated by one of skill in the art in possession of the present disclosure, such a configuration allows any particular GPU device to transmit communications to four different switch devices, providing benefits in an AI “scale-up” or “scale-out” by optimizing the simultaneous utilization of GPU devices and switch devices.

As will be appreciated by one of skill in the art in possession of the present disclosure, the switch device 202a may receive the optical communication from the electrical/optical communication conversion aggregator system 600 provided for the rack 204a via an electrical/optical transceiver device connected to the optical cable 1200, which may convert that optical communication to an electrical communication that may be processed by the switch device 202a. However, while a specific example has been illustrated and described in which the NIC device 406a in the server device 304a/400 included in the rack 204a/300 communicates with the switch device 202a, one of skill in the art in possession of the present disclosure will appreciate how any of the NIC devices 406a-406h included in any of the server devices 304/400 in any of the racks 204a-204h/300 may communicate with the switch devices 202a-202h similarly as described above.

The method then returns to decision block 706a in the loop 706. As such, the method 700 may perform the loop 706 such that optical transmitter systems in the EOCCA system convert electrical communications received from their respective networked devices to optical communications, and transmit those optical communications to any of the plurality of networking devices, whenever those optical transmitter systems receive electrical communications from their respective networked device.

With reference next to loop 708, following block 704 the method 700 may proceed to decision block 708a where the method 700 proceeds depending on whether an optical receiver system receives optical communications from any of the plurality of networking devices. As will be appreciated by one of skill in the art in possession of the present disclosure, any of the switch devices 202a-202h may transmit an optical communication (e.g., which may be a communication received by that switch device from a networked device as part of loop 706 of the method 700 described above) via an optical cable 1200 connected to that switch device and to any of the electrical/optical communication conversion aggregator systems 600 such that it is received by the one of the optical receiver systems 608-610 in that electrical/optical communication conversion aggregator system 600 that is connected to that optical cable 1200 via one of the switch device connectors 618a-618d. If, at decision block 708a, no optical receiver system receives optical communications from any of the plurality of networking devices, the method 700 returns to decision block 708a in the loop 708. As such, the method 700 may perform the loop 708 until an optical receiver system receives optical communications from any of the plurality of networking devices.

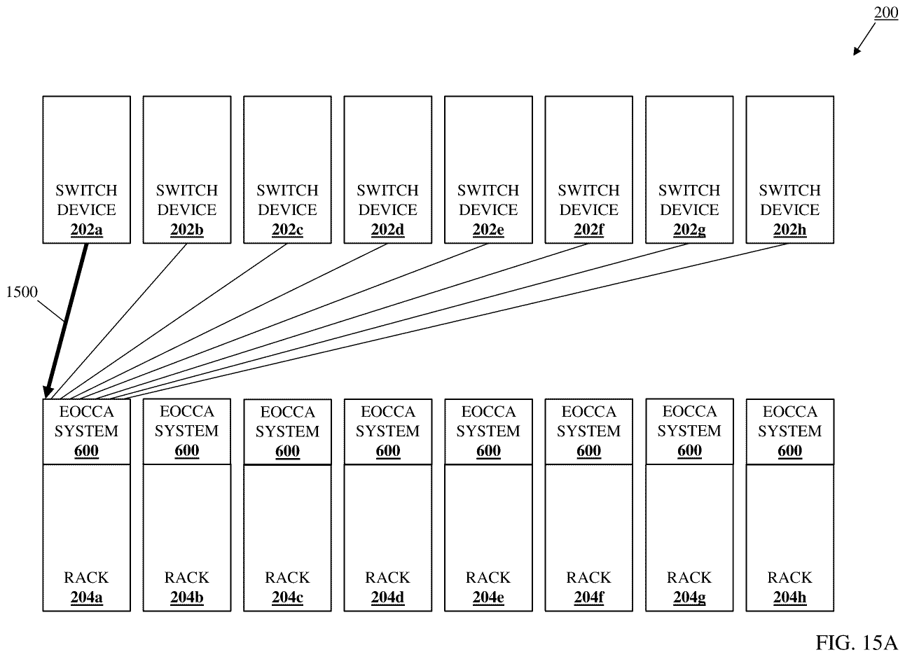

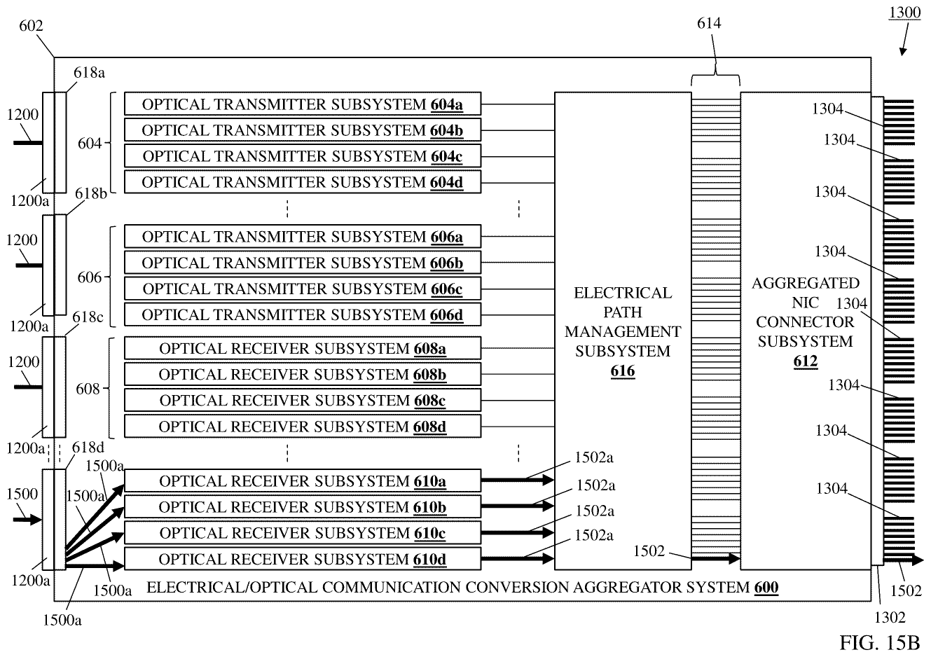

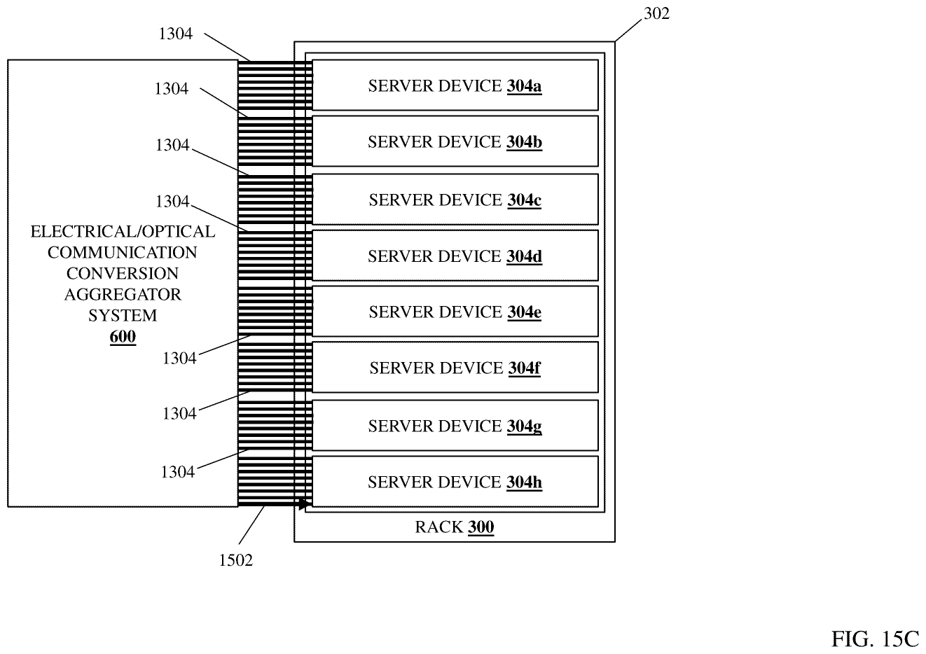

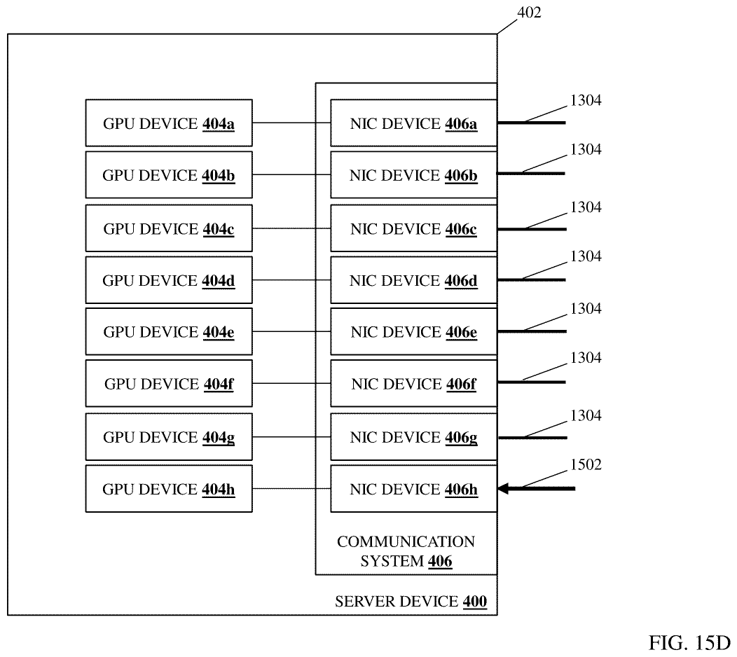

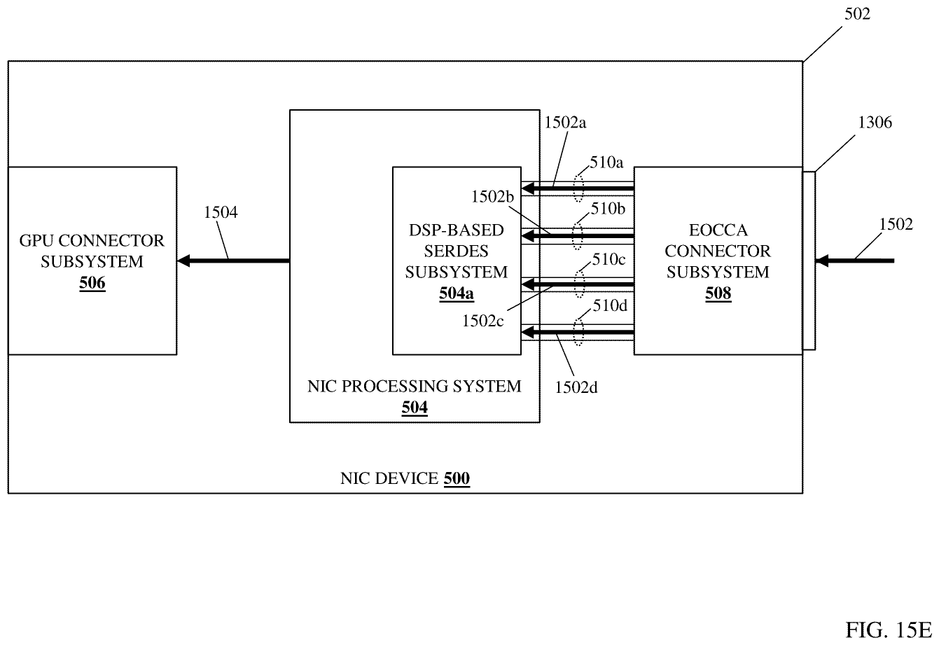

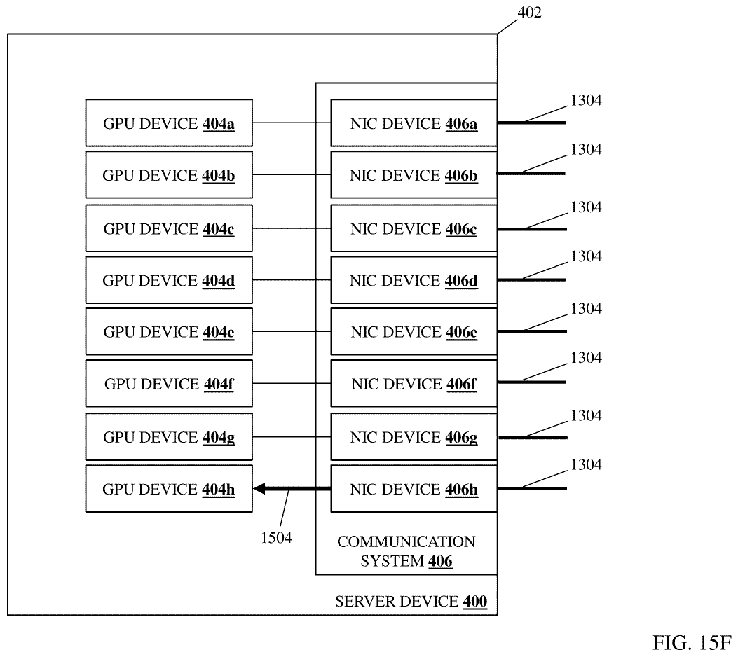

If at decision block 708a, an optical receiver system receives optical communications from any of the plurality of networking devices, the method 700 proceeds to block 708b in the loop 708 where the optical receiver system converts the optical communications to electrical communications and transmits the electrical communications to its respective networked device. To provide a specific example, with reference to FIGS. 15A and 15B, the switch device 202a may perform optical communication provisioning operations 1500 that include transmitting an optical communication via the optical cable 1200 connected to the switch device connector 618d included on the electrical/optical communication conversion aggregator systems 600 provided for the rack 204a. As will be appreciated by one of skill in the art in possession of the present disclosure, the switch device 202a may generate and transmit an electrical communication via an electrical/optical transceiver device that connects that switch device 202a to the optical cable 1200, with that electrical/optical transceiver device converting that electrical communication to an optical communication that it transmits via the optical cable 1200 and to the switch device connector 618d included on the electrical/optical communication conversion aggregator systems 600 provided for the rack 204a.

As such, at decision block 708a, the optical receiver system 610 in the electrical/optical communication conversion aggregator system 600 provided for the rack 204a may receive the optical communication (e.g., including four receive signals 1500a) from the switch device 202a via the switch device connector 618d. However, as discussed above, the optical receiver subsystems in any particular optical receiver system may be connected to different switch device connectors and, thus, different switch devices. As such, the optical communications discussed above may be received by the optical receiver subsystem 610a via the switch device connector 618a, the optical receiver subsystem 610b via the switch device connector 618b, and so on. As will be appreciated by one of skill in the art in possession of the present disclosure, such a configuration allows any particular GPU device to receive communications from four different switch devices, providing benefits in an AI “scale-up” or “scale-out” by optimizing the simultaneous utilization of GPU devices and switch devices.

At block 708b, the optical receiver system 606 in the electrical/optical communication conversion aggregator system 600 provided for the rack 204a may then perform optical-to-electrical communication conversion operations 1502 that may include the TIA (along with the analog post amplifier and the electrical post amplifier) in each of the optical receiver subsystems 610a-610d receiving a respective one of the four receive signals included in those optical communications via the optical receiver and optical fiber in that optical receiver subsystem, and using that receive signal to generate and transmit electrical communications (e.g., four electrical receive signals) to the electrical path management subsystem 616.

With reference to FIGS. 15B, 15C, 15D, and 15E, the electrical path management subsystem 616 may then perform electrical communication routing operations that include routing the four receive signals 1502a provided by the optical receiver system 610 in the electrical communication transmitted via the optical-to-electrical communication conversion operations 1502 to the aggregated NIC connector subsystem 612 to cause them to be transmitted via the electrical cable 1304 to the NIC device 406h/500 in the server device 304h/400 included in the rack 204a/300 such that those electrical communications (e.g., including the four receive signals 1502a) are received by DSP-based SERDES subsystem 504a in the NIC processing system 504 via the EOCCA connector subsystem 508 and the receive connection in each of the four differential pair connections 510a-510d. With reference to FIGS. 15E and 15F, the NIC processing system 504 may then perform electrical communication forwarding operations 1504 to forward the electrical communications via the GPU connector subsystem 506 and to the GPU device 404h.

However, while a specific example has been illustrated and described in which the switch device 202a communicates with the NIC device 406h in the server device 304h/400 included in the rack 204a/300, one of skill in the art in possession of the present disclosure will appreciate how any single lane of communications traffic from any device on the switch side may communication with any single lane of communications traffic from any device on the NIC similarly as described above.

The method then returns to decision block 708a in the loop 708. As such, the method 700 may perform the loop 708 such that optical receiver systems in the EOCCA system convert optical communications received from any of the plurality of networking devices to electrical communications, and transmit those electrical communications to their respective networked devices, whenever those optical receiver systems receive optical communications from any of the plurality of networking devices.

While not illustrated or described in detail, in some embodiments the switch devices 202a-202h (or switch-side devices) may utilize a pluggable optical module with a DSP-based retimer, or direct-drive Co-Packaged Optic (CPO) systems, in order to achieve lower power usage and enable longer connections between the networked devices and the electrical/optical communication conversion aggregator system of the present disclosure. As will be appreciated by one of skill in the art in possession of the present disclosure, when used with the switch devices 202a-202h, pluggable optical modules with DSP-based retimers, or direct-drive CPO systems, will optimize switch power efficiency while enabling a maximum “electrical connection budget” between the networked devices and the electrical/optical communication conversion aggregator system by minimizing the loss on the electrical connection between the switch optics and the DSP-based retimer or CPO system.

Furthermore, in some embodiments, a remotely configurable switch device may be provided between the optical transmitter systems 604-606/optical receiver systems 608-610 and the switch devices connectors 618a-618d (and may be integrated on the common chip with the optical transmitter systems 604-606/optical receiver systems 608-610 as described above), while optical amplifiers, wavelength division multiplexers/demultiplexers, and/or other optical subsystems may be provided for use with the electrical/optical communication conversion aggregator system of the present disclosure (either as discrete components or integrated on the common chip with the optical transmitter systems 604-606/optical receiver systems 608-610 as described above).

Thus, systems and methods have been described that aggregate the conversion between electrical communications and optical communications transmitted between a plurality of networked devices and a plurality of networking devices. For example, a networked system provided according to the teachings of the present disclosure may include networking devices, networked devices, and an electrical/optical communication conversion aggregator system. A chassis of the electrical/optical communication conversion aggregator system houses optical transmitter systems that are each coupled to a respective one of the networked devices via a respective electrical connection and to each of the networking devices via a respective optical connection, and optical receiver systems that are each coupled to each of the networking devices via a respective optical connection and to a respective one of the networked devices via a respective electrical connection. Each optical transmitter system converts electrical communications received from its connected networked device to optical communications that it transmits to any of its connected networking devices, and each optical receiver system converts optical communications received from any of its connected networking devices to electrical communications that it transmits to its connected networked device.

As will be appreciated by one of skill in the art in possession of the present disclosure, the electrical/optical communication conversion aggregator system of the present disclosure may reduce the costs to perform the electrical/optical communication conversions between the networked devices and the networking device described above via its ability to use analog, linear, direct-drive, un-retimed optics (i.e., as opposed to the use of pluggable optical transceiver modules with DSP-based retimers in conventional systems that are responsible for a relatively large fraction of the overall cost, power dissipation, and latency of such systems).

Furthermore, the electrical/optical communication conversion aggregator system of the present disclosure may also reduce the costs to perform the electrical/optical communication conversions between the networked devices and the networking device described above via the economies of scale with regard to integrated optics and/or silicon photonics used in the electrical/optical communication conversion aggregator system. In addition, the electrical/optical communication conversion aggregator system of the present disclosure may reduce costs further via the use one relatively high-powered laser to supply each of the silicon photonics modulators (i.e., rather than at least one laser per pluggable optical transceiver module as is provided in conventional systems), and/or the use of a single silicon V-grove array to couple optical fibers to the silicon photonics chip (i.e., rather than requiring an individual coupling operation for each module as in conventional systems).

Further still, the electrical/optical communication conversion aggregator system of the present disclosure may simplify power management and cooling by moving the electrical/optical communication conversion hardware and electrical/optical communication conversion operations discussed above to a single location, allowing for the focusing of power provisioning and heat dissipation operations at that single location (i.e., rather than dispersed across the locations of each of the networked devices as in conventional systems).

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A networked system, comprising:
a plurality of networking devices;
a plurality of networked devices; and
an electrical/optical communication conversion aggregator system that includes:
a chassis;
a plurality of optical transmitter subsystems that are housed in the chassis, that are each coupled to a respective one of the plurality of networked devices via a respective electrical connection and to each of the plurality of networking devices via a respective optical connection, and that are each configured to convert electrical communications received from that networked device via that respective electrical connection to optical communications and transmit those optical communications to any of the plurality of networking devices via the respective optical connection to that networking device; and
a plurality of optical receiver subsystems that are housed in the chassis, that are each coupled to each of the plurality of networking devices via a respective optical connection and to a respective one of the plurality of networked devices via a respective electrical connection, and that are each configured to convert optical communications received from any of the plurality of networking devices via the respective optical connection to that networking device to electrical communications and transmit those electrical communications to that networked device via that respective electrical connection.

2. The networked system of claim 1, wherein each of the plurality of networking devices is provided by a respective switch device.

3. The networked system of claim 1, wherein each of the plurality of networked devices is provided by at least one of: a Network Interface Controller (NIC) device and a processing device.

4. The networked system of claim 1, further comprising:
a rack housing the plurality of networked devices, wherein the electrical/optical communication conversion aggregator system is housed in the rack.

5. The networked system of claim 1, wherein at least thirty-two of the plurality of optical transmitter subsystems are integrated on a common optical chip.

6. The networked system of claim 1, wherein at least thirty-two of the plurality of optical receiver subsystems are integrated on a common optical chip.

7. An electrical/optical communication conversion aggregator system, comprising:
a chassis;
an aggregated networked device connector subsystem that is configured to couple to a plurality of networked devices via respective electrical connections;
a plurality of networking device connectors that are configured to couple to a plurality of networking device via respective optical connections;
a plurality of optical transmitter subsystems that are housed in the chassis, that are each configured to couple to a respective one of the plurality of networked devices via the aggregated networked device connector subsystem and to each of the plurality of networking devices via the plurality of networking device connectors, and that are each configured to convert electrical communications received from that networked device via the aggregated networked device connector subsystem to optical communications and transmit those optical communications to any of the plurality of networking devices via the plurality of networking device connectors; and
a plurality of optical receiver subsystems that are housed in the chassis, that are each configured to couple to each of the plurality of networking devices via the plurality of networking device connectors and to a respective one of the plurality of networked devices via the aggregated networked device connector subsystem, and that are each configured to convert optical communications received from any of the plurality of networking devices via the plurality of networking device connectors to electrical communications and transmit those electrical communications to that networked device via the aggregated networked device connector subsystem.

8. The electrical/optical communication conversion aggregator system of claim 7, wherein each of the plurality of networking devices is provided by a respective switch device.

9. The electrical/optical communication conversion aggregator system of claim 7, wherein each of the plurality of networked devices is provided by at least one of a Network Interface Controller (NIC) device and a processing device.

10. The electrical/optical communication conversion aggregator system of claim 7, wherein the chassis is configured to be housed in a rack that houses the plurality of networked devices.

11. The electrical/optical communication conversion aggregator system of claim 7, wherein at least thirty-two of the plurality of optical transmitter subsystems are integrated on a common optical chip.

12. The electrical/optical communication conversion aggregator system of claim 7, wherein at least thirty-two of the plurality of optical receiver subsystems are integrated on a common optical chip.

13. The electrical/optical communication conversion aggregator system of claim 7, further comprising:
a plurality of optical transmitter systems, wherein each of the plurality of optical transmitter systems includes four of the plurality of optical transmitter subsystems; and
a plurality of optical receiver systems, wherein each of the plurality of optical receiver systems includes four of the plurality of optical receiver subsystems.

14. A method for aggregating the conversion between electrical communications and optical communications, comprising:
coupling, by each of a plurality of optical transmitter subsystems included in a chassis of an electrical/optical communication conversion aggregator system, to a respective one of a plurality of networked devices via a respective electrical connection and to each of a plurality of networking devices via a respective optical connection;
coupling, by each of a plurality of optical receiver subsystems included in the chassis of the electrical/optical communication conversion aggregator system, to each the plurality of networking devices via a respective optical connection and to a respective one of the plurality of networked devices via a respective electrical connection;
converting, by each of the plurality of optical transmitter subsystems via the respective electrical connection between that optical transmitter subsystem and the respective one of the plurality of networked devices, electrical communications received from that networked device to optical communications and transmitting those optical communications to any of the plurality of networking devices via the respective optical connection between that optical transmitter subsystem and that networking device; and
converting, by each of the plurality of optical receiver subsystems via the respective optical connection between that optical receiver subsystem and any of the plurality of networking devices, optical communications received from that networking device to electrical communications and transmitting those electrical communications to the respective one of the plurality of networked devices via the respective electrical connection between that optical receiver subsystem and that networked device.

15. The method of claim 14, wherein each of the plurality of networking devices is provided by a respective switch device.

16. The method of claim 14, wherein each of the plurality of networked devices is provided by at least one of: a Network Interface Controller (NIC) device and a processing device.

17. The method of claim 14, further comprising:
positioning, by the electrical/optical communication conversion aggregator system, in a rack that houses the plurality of networked devices.

18. The method of claim 14, wherein at least thirty-two of the plurality of optical transmitter subsystems are integrated on a common optical chip.

19. The method of claim 14, wherein at least thirty-two of the plurality of optical receiver subsystems are integrated on a common optical chip.

20. The method of claim 14, further comprising:
a plurality of optical transmitter systems, wherein each of the plurality of optical transmitter systems includes four of the plurality of optical transmitter subsystems; and
a plurality of optical receiver systems, wherein each of the plurality of optical receiver systems includes four of the plurality of optical receiver subsystems.
